(19) United States
(12) Patent Application Publication
(10) Pub. No.: US 2017/0031287 A1
(43) Pub. Date: Feb. 2, 2017

(54) FIXING DEVICE AND FIXING METHOD

(71) Applicant: HIT DEVICES LTD., Kyoto (JP)

(72) Inventors: Hideo TANIGUCHI, Kyoto (JP); Shigemasa SUNADA, Kyoto (JP)

(21) Appl. No.: 15/219,449

(22) Filed: Jul. 26, 2016

(30) Foreign Application Priority Data
Jul. 27, 2015 (JP) 2015-148106
Dec. 28, 2015 (JP) 2015-257395
Feb. 15, 2016 (JP) 2016-026299
May 11, 2016 (JP) 2016-095626

(51) Int. Cl. G03G 15/20

(52) U.S. Cl. CPC G03G 15/2085; G03G 15/2053

(57) ABSTRACT

A fixing device includes, a transfer section (3) for transferring a toner (42) to a recording medium (41), a heating section (1) provided at a downstream side of the recording medium from the transfer section, for heating the toner transferred in the transfer section until the toner becomes a softened state or a fluidized state (molten state), and a pressing and conveying section (2) provided at a downstream side of the recording medium from the heating section and conveying the recording medium while pressurizing, with a pressure roller (21), a surface of the recording medium on which the toner is attached.

### TECHNICAL FIELD

The present invention relates to a fixing device and a fixing method for forming an image on a recording medium by heating a resin toner for forming an image to soften or fluidize the toner and adhere the toner to the recording medium or partly impregnate the recording medium with the toner, particularly to a toner fixing device and a toner fixing method for subjecting an unfixed toner image transferred to the recording medium to heating and fixing to obtain a permanent fixed image in a power saving manner without deterioration of the image.

### BACKGROUND OF THE INVENTION

Electrophotographic recording is used widely for copying machine, a printer, or the like. Electrophotographic recording is performed in a manner as mentioned below. Namely, a toner is attached electrostatically to a photoreceptor (a photoconductor drum, a belt-like photoreceptor, a sheet-like photoreceptor, or the like) by electrostatic charging, exposing and developing and then is moved and transferred to the recording medium by electrostatic attraction. Then, the toner is fluidized by heating with a heating and pressing roller to give rise to adhesiveness of the toner, thereby causing cohesion of toners and adhesion of toner to the recording medium. As a result, the toner will not move freely. In other words, softening, fluidization and adhesion arise and then, by pressing the toner in an adhered state, an image is fixed to the recording medium.

In a method of fixing the toner on the recording medium having a transferred toner thereon, it is known that the recording medium travels, while being pressed, for example, with a heating roller heated with a built-in halogen lamp and a pressure roller located opposite to the heating roller. Namely, pressing and heating are conducted simultaneously. Thus, a recording medium on which the toner has been transferred is moved while rotating the heating roller and the pressure roller, and therefore, the surface of the toner is hardly rubbed. However, since the recording medium is pressed with the pressure roller while the toner is in a completely fluidized state, the softened and fluidized toner attaches to the surface of the heating roller and a part of the toner surface is peeled off. Also, it is necessary to have a halogen lamp built inside the roller. Therefore, there is a problem such that power consumption is high and it takes time until the temperature of the heating roller is elevated sufficiently after turning on a switch. In order to solve this problem, it is necessary to preheat the roller. Thus, further power consumption is required and it is impossible to comply with a demand for energy saving.

Meanwhile, a method of using a ceramic heater, in which a heating element is formed on a surface of a ceramic substrate, has been proposed. However, in this method, in order to efficiently use heat of the ceramic heater, heating and pressing are carried out with the surface of the heater being brought into contact with a portion of a recording medium on which a toner has been transferred. In addition, the ceramic heater cannot be rotated unlike a roller. The recording medium is carried while the surface of the ceramic heater is rubbed with the surface of the recording medium on which a toner has been transferred. As a result, the whole or a part of the toner is apt to be damaged before being fixed. Therefore, as shown, for example, in JP H05-273879 A or “SURF and ODF” (Journal of the Imaging Society of Japan, Vol. 48, No. 5, pp. 411-416, 2009), there is employed a method of disposing a heat-resistant film (sheet) made of polyimide or the like between the ceramic heater and the recording medium and carrying the recording medium by carrying the heat-resistant film synchronously with a transfer speed of the recording medium.

Also as shown, for example, in “Electrophotograph” (Ed. by The Imaging Society of Japan, Issued by Publication Dept. of Tokyo Denki University, Jun. 20, 2008, pp. 67-69), a corona discharge method, a roller transfer method, and the like are known as the method for transferring a toner from a photoreceptor to a recording medium. The corona discharge method has, as shown in FIG. 8A, a configuration such that a transfer charger 82 and a separate charger 83 are disposed opposed to the photoreceptor 81 with the recording medium 80 being disposed between the photoreceptor 81 and the chargers 82, 83. In this configuration, an electric latent image (invisible reverse image) is formed on a surface of the photoreceptor 81 by uniformly charging the entire surface of the photoreceptor 81 with a charger unit 84 and emitting a laser beam or LED from a light source 85 onto the photoreceptor 81 on which a printing data pattern has been charged.

Then, in a developer unit 86, a toner is adhered to the latent image formed on the surface of the photoreceptor 81 while stirring the toner, thus forming a visible image on the surface of the photoreceptor 81. Thereafter, the toner on the photoreceptor 81 is transferred onto the recording medium 80 by giving an electric charge antipolar to the toner onto the back surface of the recording medium 80 through corona discharging by the transfer charger 82. An electric field weaker than that of the transfer charger 82 has been applied to the separate charger 83 so that the recording medium 80 should not be sucked by the photoreceptor 81 and wound on the photoreceptor 81. Namely, in the transfer section, the photoreceptor 81 and the transfer charger 82 are disposed in pairs independently to form a transfer device. Further, in a roller transfer method, as shown in FIG. 8B, a toner image is transferred to the recording medium 80 not only by pressing a transfer roller 89 disposed opposed to the photoreceptor 81 via the recording medium 80 onto the photoreceptor 81 with a proper contact pressure and conveying the recording medium 80 but also giving an electric charge antipolar to the toner on the back surface of the recording medium 80 through the transfer roller 89.

### SUMMARY OF THE INVENTION

### Problem to be Solved by the Invention

As mentioned above, in the event of heating and pressing a transferred toner via the heat-resistant film, since the heating is conducted indirectly via the heat-resistant film, much amount of heat is required. As a result, there is a problem that even if a ceramic heater is used, power consumption cannot be reduced sufficiently. Further, there is a problem that since the heat-resistant film needs to be moved coincidently to a transfer speed of the recording medium, a complicated configuration is required.

Furthermore, as mentioned above, if fluidization and adhesion of the toner are carried out simultaneously, the fluidized toner is apt to stick to a heating/pressing roller or an intervening heat-resistant film, and a part of the toner image is lost, thereby causing a problem that the image becomes unclear. In addition, in such heating, since the heating and the pressing are conducted from the surface side of the toner, firstly the toner of the surface side is formed into a fluidized state earlier than the toner at the recording medium side, and the pressing is conducted in such a state. Therefore, there is a problem that the toner is apt to stick to the heat-resistant film (a heating/pressing roller) rather than impregnating into the recording medium.

Further, in the case where the recording medium is a material having hygroscopic property such as paper, for example, as shown in FIG. 7, there is a problem that the toner-transferred recording medium 71 is heated while being pressed with the pressure roller 75 and the rotating roller 76, and moisture in the recording medium 71 is heated, thereby causing blisters 73, which pass through the fluidized toner 72, and as a result, concave portions 74, so-called a blister, are formed on the surface of the fluidized toner 72, and uneven surface is formed on the toner 72, which makes a displayed image unclear.

Also, when heating is performed from the surface side of the transferred toner, even if the surface side of the toner is in a fluidized state, fluidization of the toner at its surface side contacting with the recording medium is delayed compared with the fluidization at the surface side, and therefore, adhesiveness of the toner to the recording medium is apt to insufficient. Further, in a state of the toner being transferred to the recording medium, the toner is only adhered to the recording medium with a week electrostatic force, and the toner is covered with an external additive. Therefore, fine powders of the toner and the external additive are apt to scatter during a period of time until the recording medium reaches the heating roller and the pressure roller, and dust floats in the air, which may result in environmental pollution.

Furthermore, when the heating and the pressing are conducted simultaneously, the heating and the pressing must be carried out during an interval of a width of a contacting portion (nip width) where the heating and pressing roller comes into contact with the rotation roller. Therefore, when the transfer speed of the recording medium is fast, sufficient fixing cannot be made, and thus there is a restriction in a printing speed.

The present invention has been made to solve such problems as mentioned above, and an object of the present invention is to provide a fixing device and a fixing method, which assure that a vivid fixed image can be obtained by configuring a heating section and a pressing and conveying section separately and maintaining a temperature of the pressing and conveying section at a certain level, without disposing the heat-resistant film between the transferred toner on the recording medium and a heating substrate, thereby causing no damage of the transferred toner, and that a power-saving heating substrate which has a heating element formed on its surface and is capable of quick start can be used.

Another object of the present invention is to provide a fixing device and a fixing method, which assure that scattering of the toner can be prevented by enabling the toner to be heated immediately after the transferring of the toner.

Yet another object of the present invention is to provide a fixing device and a fixing method, which assure that the toner can be fixed to the recording medium at a high speed without damaging the toner surface.

Still another object of the present invention is to provide a fixing device and a fixing method, which assure that even in the case where the recording medium is one having hygroscopic property such as paper, the toner image can be prevented from becoming unclear by evaporation of moisture of the recording medium.

Further object of the present invention is to provide a fixing device and a fixing method, which assure that while scattering of a fine powder is prevented by heating the transferred toner immediately after the transferring, the toner temperature can be decreased at a pressing and conveying section so that the toner can be stuck to the recording medium without allowing the toner to be formed into a fluidized state (into a molten state).

### Means to Solve the Problem

The fixing device of the present invention comprises: a transfer section for transferring a toner formed on a photoreceptor to a recording medium, the toner being attached by developing an electrostatic latent image, a heating section provided at a downstream side of the recording medium from the transfer section, for heating the toner transferred in the transfer section, and a pressing and conveying section provided at a downstream side of the recording medium from the heating section for conveying the recording medium while pressing, with a pressure roller, a surface of the recording medium on which the toner is attached, wherein in the heating section, heating is performed by a first heating substrate from the other side of the recording medium than the surface on which the toner is transferred and/or a second heating substrate from the side of the surface on which the toner was transferred, the second heating substrate being provided apart from the recording medium, and the heating is continued until the toner transferred on the recording medium becomes a softened state or a fluidized state, and in the pressing and conveying section, the recording medium is pressurized at a temperature below a temperature at which the recording medium is in a softened state or in a fluidized state, wherein in the pressing and conveying section, an extension part of the first heating substrate or a fourth heating substrate which is different from the first heating substrate is provided opposite to the pressure roller with the recording medium being disposed therebetween, and the recording medium is subjected to pressing with the pressure roller and the first heating substrate or the fourth heating substrate.

Here, the downstream side means a front in the traveling direction of the recording medium and the roller, namely means a paper discharging side in the case of the recording medium. Reversely upstream side means, in the case of the recording medium, a supply side thereof. Further, a softened state means a state of a toner such that in a viscoelastic property of a toner to be explained infra, the toner is within a temperature range in a rubber region (softening region), and has a resilience in which viscoelasticity of the toner becomes to be lower than in a solid region and the toner is deformed easily by an external force, and a fluidized state means a state of the toner being capable of flowing in a liquid form. It is a matter of course that even in the case of the rubber state, as the temperature is higher, viscoelasticity decreases, and the toner is close to the fluidized state, and even in the case of a fluidized state, as the temperature is higher, flowability increases.

The first heating substrate can be configured to have a structure such that the first heating substrate is extended up to a position where an extended portion of the first heating substrate is located opposed to the pressure roller with the recording medium being disposed therebetween and a heating element is not formed on the extended portion opposed to the pressure roller. The fixing devise further comprises an insulating substrate that is continuously provided throughout the transfer section, the heating section and the pressing and conveying section and comes into contact with a back surface of the recording medium opposed to the surface on which the toner is attached, wherein an electrode for transferring is provided on the insulating substrate for the transfer section, a heating element is provided on the insulating substrate for the heating section, wherein the heating element and the insulating substrate constitute the first heating substrate, and in the pressing and conveying section, the insulating substrate is formed as a support for receiving a pressure of the pressure roller.

Here, “continuously” means that the insulating substrate is not always integrated completely, and connection thereof may be made using an adhesive or the like so as to obtain good heat conductivity along the travelling direction of the recording medium 41. Further, in the vertical direction of the travelling direction of the recording medium, a plurality of heating substrates may be provided apart from each other.

Furthermore, it is preferable that a fifth heating substrate for heating the recording medium is provided at an upstream side of the recording medium from the transfer section, thereby enabling moisture contained in the recording medium to be evaporated beforehand. This fifth heating substrate is used effectively irrespective of the structure of the first heating substrate. Thus the toner can be heated just before the transferring and immediately after the transferring, thereby preventing degradation of an image and scattering of the toner powder.

The fixing method of the present invention is characterized in that a toner is fixed to a recording medium by providing a transfer section for transferring the toner showing an image on one surface of the recording medium, by an electrophotographic process, providing a heating section for changing the toner from a solid state to a softened state or a fluidized state by heating the toner from a side of the toner-transferred surface of the recording medium apart from the surface, and/or from an opposite side of the recording medium while carrying the recording medium, and providing a pressing and conveying section for carrying the recording medium while pressing it, wherein the recording medium having the toner become to a softened state or a fluidized state is conveyed between a pressure roller provided at the toner side of the recording medium and a first heating substrate disposed at an opposite side of the recording medium or a fourth heating substrate different from the first heating substrate, to be pressed at a temperature of the toner which is not higher than a temperature of the toner at the heating section.

In the case of pressing with the pressure roller, the pressing can be carried out while heating the recording medium at a temperature equal to or lower than a temperature of the toner in the softened state with interposing the recording medium between the pressure roller and an extending portion, in which a heating element is not provided, of an insulation substrate of the heating substrate of the heating section by using heat conducting through the insulating substrate. An insulating substrate may be continuously provided throughout the transfer section, the heating section and the pressing and conveying section, and an electrode for transferring at the transfer section and a heating element for heating at the heating section are provided respectively on a surface of the insulating substrate, and an extended part of the insulating substrate is formed as a support of the pressing and conveying section.

Another embodiment of the fixing method of the present invention is a method for fixing a toner transferred at a transfer section on a recording medium, while conveying the recording medium successively through the transfer section, a heating section and a pressing and conveying section, the method being characterized in that a fine powder of the toner is prevented from scattering by heating the transferred toner immediately after the transferring at the transfer section.

### Effect of the Invention

According to the fixing device and the fixing method of the present invention, the heating section for heating the transferred toner so that the toner is in a softened state or in a fluidized state (in a molten state) and the pressing and conveying section for carrying the recording medium while fixing the toner under pressure are separated from each other so that the heating substrate is not slid on the recording medium with the transferred toner. And, in the heating section, the toner is heated to be in a softened state or in a fluidized state, and is adhered to the recording medium. Therefore, the toners do not move individually and the image is not deteriorated by pressing with the pressure roller in the pressing and conveying section. Accordingly, there is no need of disposing a heat-resistant film between the toners and the pressure roller. Namely, at the pressing and conveying section, a temperature of the toner decreases and viscoelasticity of the toner becomes large. Therefore, possibility of the toner adhering to the pressure roller is decreased to a great extent. In this case, if the temperature of the pressing and conveying section decreases greatly, sufficient adhesion cannot be obtained. Therefore, it is preferable that in the pressing and conveying section, heating is carried out at a temperature equal to or lower than the temperature of the toner in the softened state.

In the pressing and conveying section of the present invention, at a position opposite to the pressure roller via the recording medium is provided, as a support portion, an extended portion of the first heating substrate of the heating section, or a fourth heating substrate disposed separately from the first heating substrate or a part of the continuous insulating substrate having a heating element formed on the substrate. Therefore, the temperature of the toner heated at the heating section does not decrease rapidly and there is no case where the toner does not impregnate into the recording medium. This is because the temperature of the support portion increases due to heat conduction from the heating section even if the extended portion or the insulating substrate does not have a heating element on that portion, when the substrate is continuous up to the pressing and conveying section. Therefore, a properly low temperature is maintained with preventing a sudden temperature drop, and the temperature of the pressing and conveying section is not higher than that of the heating section.

As a result, deterioration of the toner image hardly arises. In addition, since the heating section is heated by the heating substrate composed of the heating element formed on the ceramic substrate, it is possible to conduct on-demand heating assuring good responsibility. Therefore, even if usually the heating section is turned off or is kept at a low preheating temperature, when starting the fixing device, the temperature can be elevated immediately, thus greatly contributing to power saving and enabling an accurate image to be fixed completely.

Further, by separating the heating section from the pressing and conveying section, the toner image can be heated nearly at the same time as the transferring. Therefore, during the carrying of the recording medium, the toner is formed into a softened state, which makes it possible to prevent scattering of a toner powder, and as a result, contributes to prevention of environmental pollution. Also, by increasing a length of the heating section, sufficient heating can be conducted, and in the pressing and conveying section, the pressing is carried out only by pressing mechanically, and therefore, it is possible to conduct the pressing in a short period of time. As a result, the carrying speed of the recording medium can be increased, and it is possible to increase the number of hourly printed matters to a great extent. Furthermore, according to the present invention, since the heating can be done from the back surface side of the recording medium, adhesion of the toner to the recording medium can be easily obtained.

Also, since the fifth heating substrate for heating the recording medium before the transferring is provided, moisture contained in the recording medium can be evaporated, and even if the moisture is not evaporated completely, it is removed easily at the following heating section. Therefore, it is possible to prevent an uneven surface of the toner due to blisters caused by the heating of the toner into a fluidized state as well as the elevation of the temperature of the recording medium. As a result, a very glossy clean image can be fixed to the recording medium. Furthermore, since the temperature of the recording medium has been increased at the time of the transferring, the temperature of the transferred toner increases immediately by the heating after the transferring and the toner becomes a softened state, thereby enabling scattering of the toner powder to be prevented more. Particularly in color printing, in many cases, four-color toner images are overlapped and transferred in a belt-like form, and then finally fixed. In these cases, toners of different colors are overlapped and transferred, and when the recording medium temperature has been increased before the transferring, scattering of the toners and deterioration of the image can be easily prevented, which is very effective.

Furthermore, since the insulating substrate provided with a heating element on its surface is formed continuously at least from the transfer section to the pressing and conveying section, even at the transfer section, where a heating element is not provided on the insulating substrate, temperatures of the insulating substrate and the recording medium have been elevated, and therefore, the toner is heated to a certain extent just after the transfer. However, since it is better not to increase the temperature of the photoreceptor from the viewpoint of its service life, the heating element provided upstream thereof is designed so as to inhibit heat generation and elevation of temperature thereof. Further, since the heating element can be formed in the vicinity of the electrode for transferring, the toner is fully heated immediately after the transferring. As a result, not only a period of time for forming the toner into a softened state of a fluidized state (a molten state) can be decreased but also scattering of the toner can be surely inhibited. In addition, the insulating substrate is provided on the surface (back surface) of the recording media opposite to the surface on which the toner is transferred, and the heating element is formed on the surface of the insulating substrate, and therefore, the heating is conducted from the back surface of the recording medium. As a result, the toner is also softened from the recording medium side to be in a fluidized state. Namely, adhesion of the toner to the recording medium is very good. Thus, when the toner is pressed at the pressing and conveying section, and the toner temperature is decreased and the toner surface becomes not in a fluidized state, it becomes easy to adhere the toner to the recording medium.

Further, in a conventional method for performing heating and pressing simultaneously, the heating and pressing of the toner are carried out only at a contact portion (a nip portion) of a heating/pressing roller with a rotation roller. Therefore, a passing time during which a recording medium passes through the nip portion is short, and minute adjustment is required for a heating temperature and a pressure. In such a conventional device for printing 40 sheets of recording mediums per minute, the passing time at a 5 mm long nip portion is about 25 ms at a conveying speed of 200 mm per sec. However, in the present invention, the heating section is separated from the pressing and conveying section and only pressing is required on the pressure roller. Therefore, the recording medium can be carried, for example, in as very short period of time as about 10 ms. Thus, 2.5 times increase in speed can be achieved. Namely, a printing speed can be increased greatly. For fluidization of a toner at the heating section, even if a conveying speed of the recording medium is fast, heating is carried out by increasing a heating distance. Therefore, a printing speed can be increased.

### BRIEF DESCRIPTION OF THE DRAWINGS

FIG. 1A is a schematic diagram of a fixing device of one embodiment of the present invention.

FIG. 1B is a schematic diagram of a fixing device of another embodiment of the present invention.

FIG. 1C is a cross-sectional view of a fixing device of still another embodiment of the present invention.

FIG. 2A is a plan view illustrating one embodiment of a heating substrate.

FIG. 2B is a view illustrating B-B cross-section of FIG. 2A.

FIG. 2C is a plan view similar to FIG. 2A for illustrating a variation of a heating substrate.

FIG. 2D is a plan view similar to FIG. 2A for illustrating a variation of a heating substrate.

FIG. 2E is a plan view similar to FIG. 2A for illustrating a variation of a heating substrate.

FIG. 2F is a side view illustrating another structural example of vacuum evacuation.

FIG. 2G is a schematic diagram illustrating a surface of an insulating substrate of FIG. 1C.

FIG. 2H is a schematic diagram illustrating a variation of FIG. 2G.

FIG. 2I is a view illustrating 2I-2I cross-section of FIG. 2H.

FIG. 3A is a view illustrating a usual change of viscoelasticity to a temperature of a resin powder constituting a toner.

FIG. 3B is a view illustrating a change of viscoelasticity to a temperature of a toner in an actual period of time from transferring to fixing of a toner.

FIG. 4A is a cross-sectional view of another embodiment of a heating substrate.

FIG. 4B is a plan view of FIG. 4A.

FIG. 5A is an enlarged view illustrating separation of a toner being in a fluidized state when being pressed with a low temperature pressure roller.

FIG. 5B is an enlarged view illustrating separation of a toner being in a fluidized state when being pressed with a high temperature pressure roller.

FIG. 6A is a view illustrating an example of a drive circuit for controlling an insulating substrate of a heating substrate at a given temperature.

FIG. 6B is a circuit diagram illustrating an example of substrate temperature control.

FIG. 6C is a view illustrating another example of a drive circuit for controlling an insulating substrate of a heating substrate at a given temperature.

FIG. 7 is a schematic diagram illustrating a state of a blister (unevenness on a toner surface) being formed due to moisture in a recording medium.

FIG. 8A is a view illustrating an example of a conventional transfer device.

FIG. 8B is a view illustrating another example of a conventional transfer device.

### DETAILED DESCRIPTION

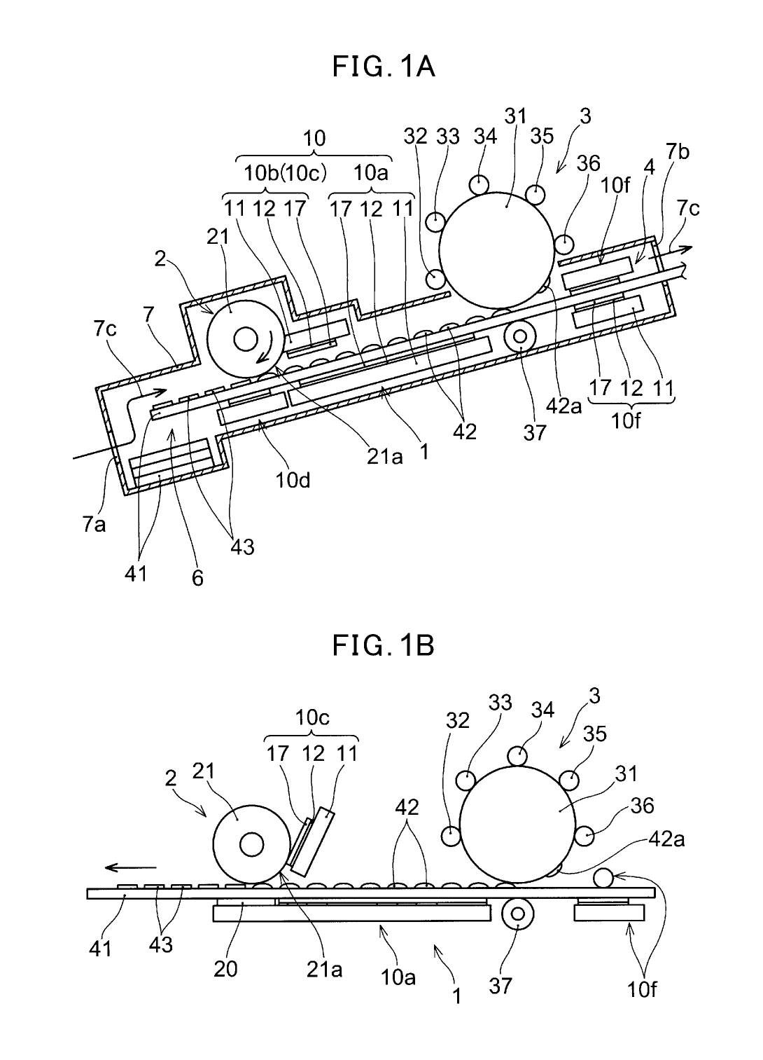

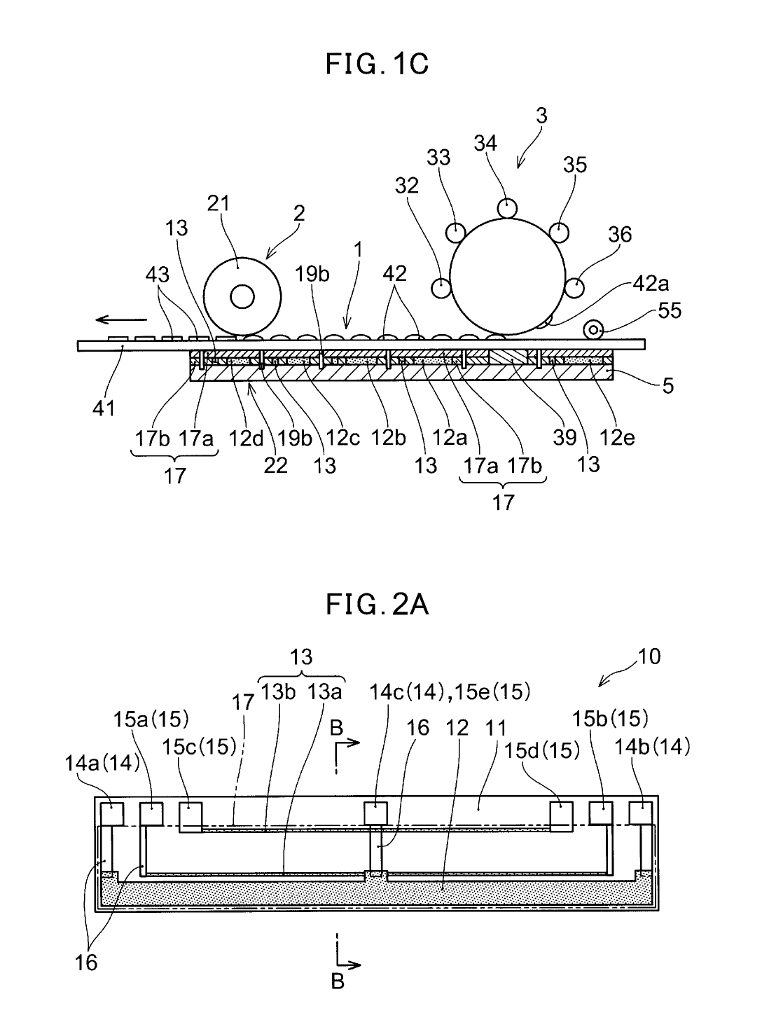

Next, the fixing device and the fixing method of the present invention are explained in detail by referring to the drawings. As shown in FIG. 1A illustrating a schematic diagram of one embodiment of the present invention, the fixing device of the present invention includes a transfer section 3 wherein an electrostatic latent image formed on a photoconductor drum 31 is developed and an attached toner is transferred to a recording medium 41, a heating section 1 which is disposed downstream of the transfer section 3 in a travelling direction of the recording medium 41 and heats the toner 42 transferred at the transfer section 3, and a pressing and conveying section 2 which is disposed downstream of the heating section 1 in the travelling direction the recording medium 41 and carries the recording medium 41 while pressing, with a pressure roller 21, a surface of the recording medium 41, on which the toner 42 is attached. In the heating section 1, heating is performed by a first heating substrate 10a from an opposite side to the surface of the recording medium 41 on which the toner 42 is attached, and/or a second heating substrate 10b from the side of the surface of the recording medium 41 on which the toner 42 is attached, wherein the second heating substrate 10b is provided apart from the recording medium 41, and the heating is performed so that the toner 42 transferred on the recording medium 41 becomes a softened state or a fluidized state (a molten state), and in the pressing and conveying section 2, the toner is pressed to the recording medium at a temperature equal to or lower than a temperature of the toner at which the toner is in a softened state or in a fluidized state in the heating section 1, wherein the pressing and conveying are performed by pressing the recording medium 41 between the pressure roller 21 and an extended part of the first heating substrate 10a or a fourth heating substrate 10d different from the first heating substrate 10a.

Namely, in conventional fixing devices, as mentioned above, when aiming at power saving without using a halogen lamp, the fixing must be carried out by heating and pressing with a heat-resistant film being disposed between a ceramic heater and a surface of a recording medium on which a toner was attached so that the toner-transferred surface should not be rubbed directly with the ceramic heater. Therefore, there is a problem that heat from the ceramic heater is not conducted directly to the toner-transferred surface and thus there is much loss of heat. Further, not only the heat-resistant film becomes a heat resistance but also its temperature decreases during the rotation of the heat-resistant film. Therefore, re-heating the heat-resistant film is necessary, which results in further power consumption. Furthermore, the heat-resistant film must be carried synchronously to a speed of the recording medium, resulting in complicated mechanism.

The present invention is characterized in that by changing a conventional idea of performing both heating and pressing of the toner simultaneously, the heating section 1 for heating the toner transferred to the recording medium to change the toner from a solid state to a softened state or a fluidized state (molten state) is separated from the pressing and conveying section 2 for pressing the toner 42 to the recording medium 4 while cooling the toner 42; thereby the heating substrate 10 mainly composed of a ceramic heater being used, and the recording medium 41 being carried while being pressed directly with a rotation roller (the pressure roller 21). The pressing and conveying section 2 is configured such that the extended part of the first heating substrate 10a or the fourth heating substrate 10d is used at a position opposite to the pressure roller 21 with the recording medium 41 disposed between the heating substrate and the pressure roller 21, thereby allowing the recording medium 41 to be pressed.

By using such a configuration, the toner 42 is heated in the heating section 1 to be changed from the solid state to a softened state or a fluidized state and impregnated into the recording medium 41, and then is subjected to pressing by the pressure roller 21 in the pressing and conveying section 2, resulting in decrease in its temperature and fixing the toner to the recording medium. In this case, since the first heating substrate 10a or the fourth heating substrate 10d is provided as a support at a position opposite to the pressure roller 21 with the recording medium 41 disposed between the heating substrate and the pressure roller 21, the temperature of the toner 42 does not decrease rapidly and the toner is not solidified. As a result, the toner hardly sticks to the pressure roller 21 side and deterioration (loss) of the toner 42 hardly arises. In addition, in the pressing and conveying section 2, it is sufficient to apply a force instantly, and also sufficient heating can be performed by increasing the travelling distance in the heating section 1, which makes it possible to increase the conveying speed of the recording medium 41 and enables the number of sheets to be treated per minute to be increased.

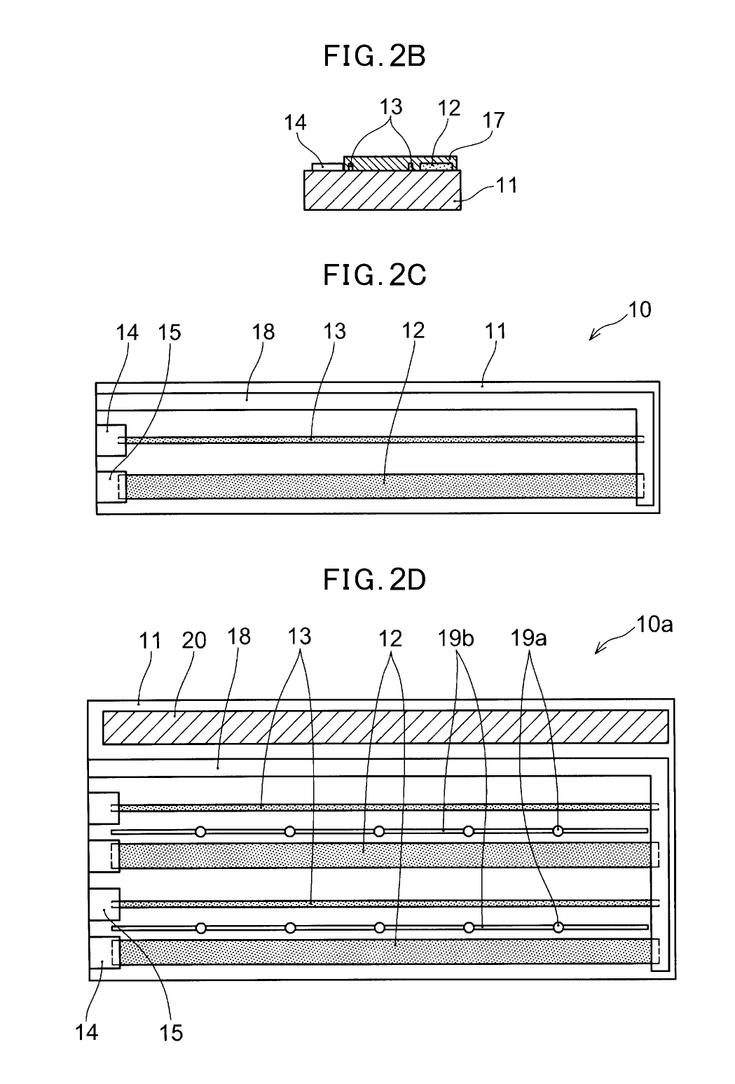

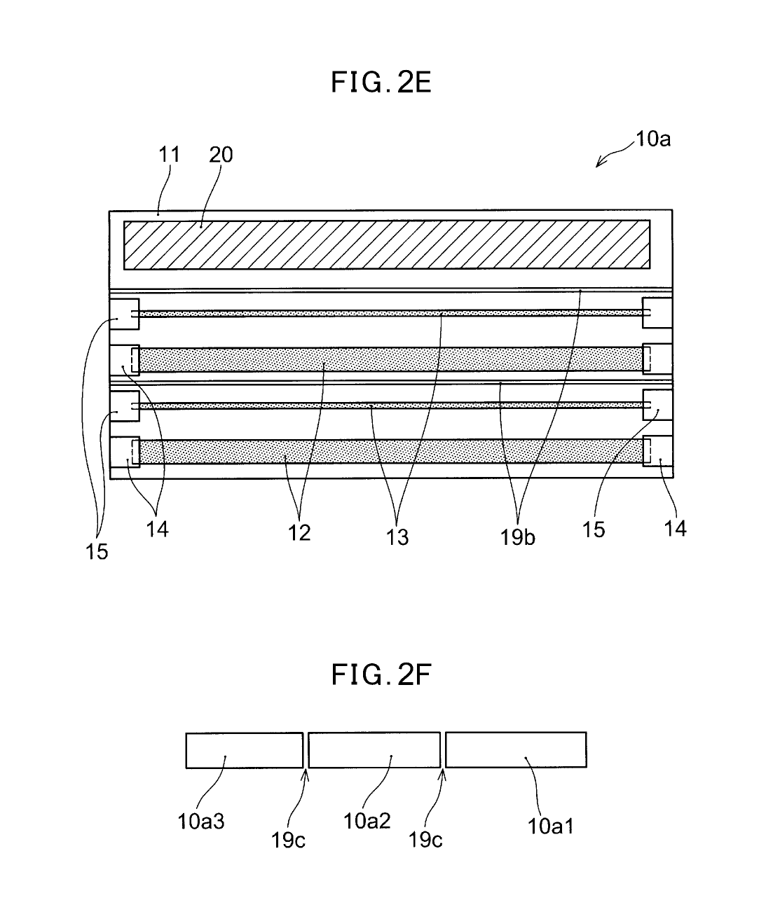

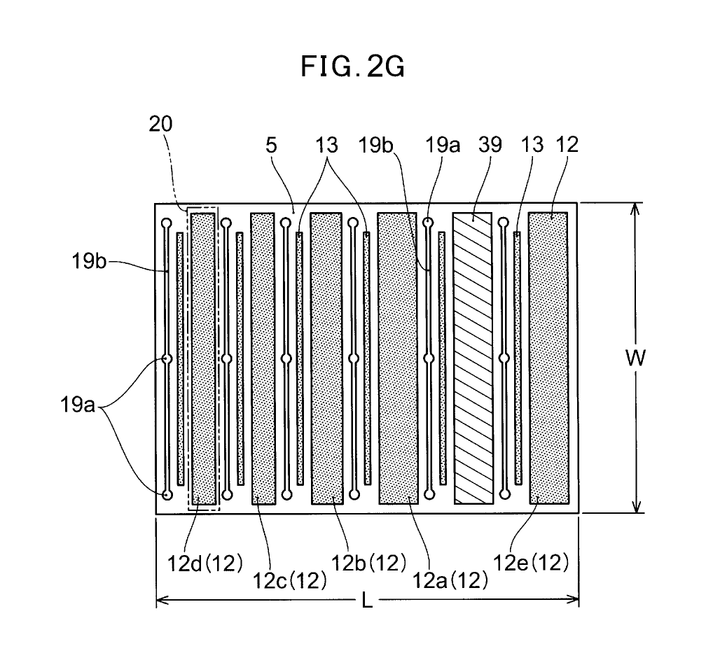

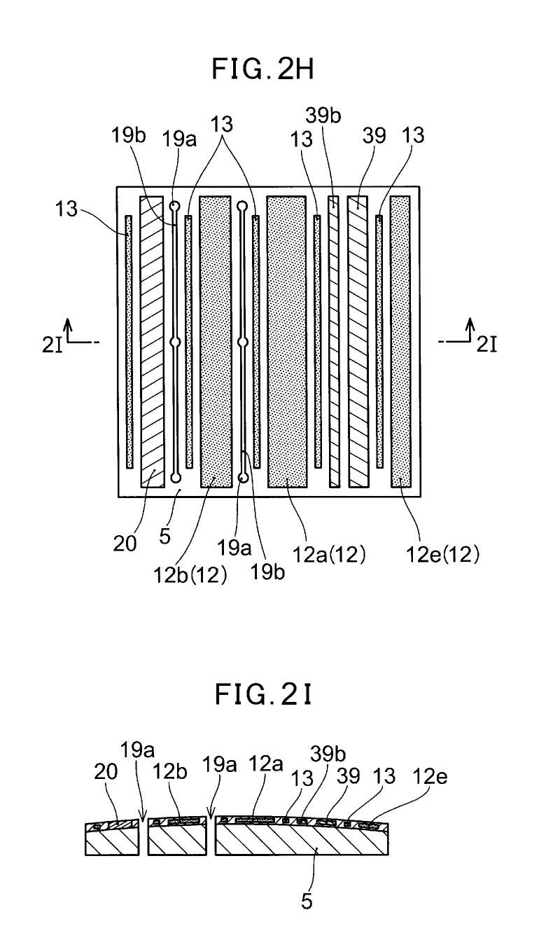

In the above-mentioned example, the fourth heating substrate 10d is provided at a position opposed to the pressure roller 21 with the recording medium 41 disposed between the heating substrate 10d and the pressure roller 21. Meanwhile, as shown in FIGS. 1B and 2D, the pressing and conveying section 2 may be configured such that the first heating substrate 10a is extended up to the position opposed to the pressure roller 21 with the recording medium being disposed between the heating substrate 10a and the pressure roller 21, and the heating element 12 is not provided on the portion of the first heating substrate 10a which is opposed to the pressure roller 21. In this case, as shown in FIG. 2D, it is preferable that an abrasion resistance layer 20 (a layer for preventing abrasion) is formed. Further, as shown in FIG. 1C, an electrode 39 for transferring may be provided on the surface of the insulating substrate 5 in the transfer section 3 which faces to the recording medium 41; heating elements 12 (12a, 12b, 12c) may be provided on the surface of the insulating substrate 5 in the heating section 1; and the insulating substrate 5 may be provided in the pressing and conveying section 2 as a support 22 for receiving a pressure of the pressure roller 21, and in this portion, while the fourth heating element 12d is provided in FIG. 1C, but it may not be provided. Examples thereof are explained hereinbelow.

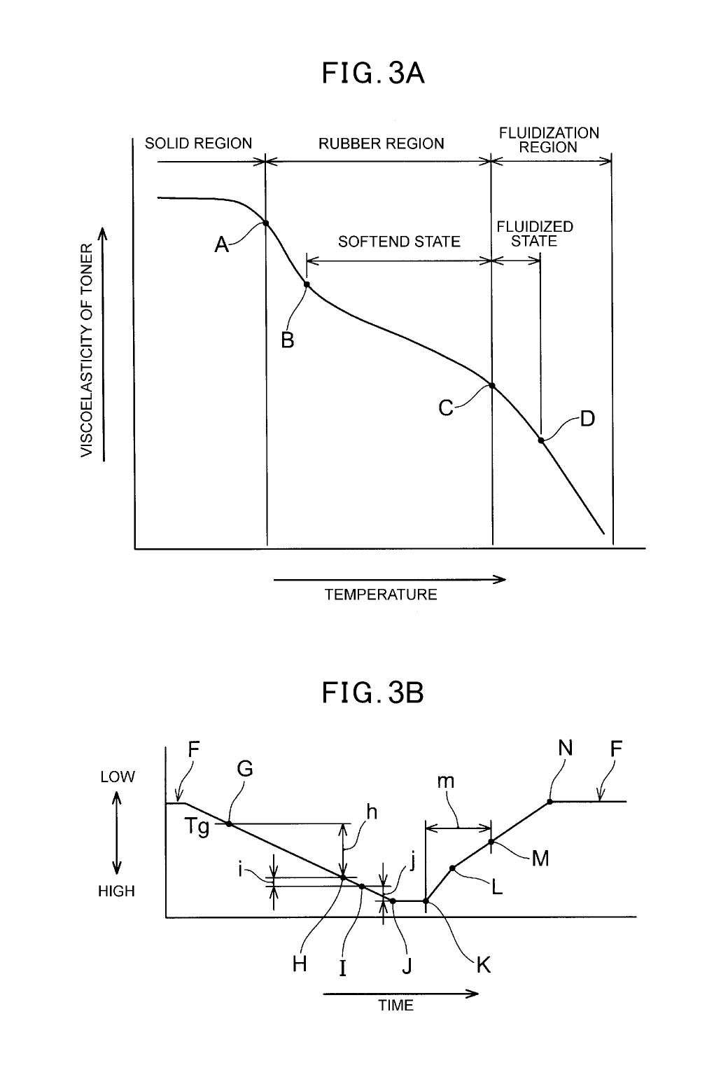

Here, the softened state or the fluidized state (molten state) of the toner 42 in the heating section 1 is explained. The toner is prepared by mixing various components. For example, a main component is an acryl-styrene copolymer, and its mixing ratio can be set at various ratios. Also other components such as a plastic, a pigment, a dye, a plasticizer (for adjusting hardness) and a wax (related to starting of softened state or fluidized state) are mixed. Further, an external additive (small particles comprising titanium oxide, silica and the like and having a size of not more than 1 μm are adhered to the outside of the toner particles so that the toner particles do not adhere to each other) is also mixed. Therefore, though it is difficult to show characteristics of the toner unconditionally, an example of a change of viscoelasticity of the toner 42 to a temperature is illustrated as a general characteristic in FIG. 3A. Generally it is known that as a temperature of a toner increases, its viscoelasticity decreases. In FIG. 3A, a point A is a glass transition point (a glass transition point of PET which is an example of a plastic used as a toner is from 68° to 80° C., and a glass transition point of an acryl-styrene copolymer is about 105° C.), which is a temperature at which a plastic changes from a solid region to a rubber region. This glass transition point is a temperature at which a plastic changes from a solid region to a rubber region, but is not enough for the toner to impregnate into the recording medium such as paper because viscoelasticity does not decrease so abruptly from a solid state. Actually, at a temperature higher than this temperature (glass transition point) by 20° to 50° C. and higher than a point B of temperature change where a state of viscoelasticity changes from abrupt lowering to slow lowering, the toner is apt to be impregnated between fibers of paper or the like due to an applied pressure. Therefore, monochrome printing can be made at a temperature higher than the point B.

Also, in color printing, if toner particles are very small, it is possible to carry out mixed printing by pressing the toner particles. However, in general terms, a temperature region suitable for monochrome printing is applied to such mixed printing. If the temperature is further increased, there appears a point C of temperature change where lowering of viscoelasticity becomes abrupt again (212° to 265° C. in the case of PET, and about 200° C. in the case of an acryl-styrene copolymer). However, absolute values of these temperatures change according to a composition of the toner and are not stable. The temperature of this point C is a point where the toner changes from a rubber region to a fluidization region and is generally called a temperature where melting or fusion begins. In the region from the point B to the point C of temperature change, the toner is in a state softened to an extent so as to be impregnated between paper fibers by applying a pressure to the toner as explained above. As mentioned above, in this region, monochrome printing can be made without any problem, and the temperature range between the points B and C is called a softened state.

Meanwhile, in the case of color printing, it is necessary that toners having different colors are mixed sufficiently. Therefore, there is a case where clean printed matter cannot be obtained with a normal grain size of a toner only by forming into a softened state. However, when the toner temperature reaches a temperature in the fluidization region of not less than the point C of temperature change as shown in FIG. 3A, toners are mixed sufficiently and even in the case of color printing, clean printed matter is easily obtained. However, as mentioned above, color printing is not limited to this temperature region. Monochrome printing can also be made in the fluidization region. Meanwhile, if the toner temperature becomes too high and the toner is severely fluidized, the toner may flows out over a desired pixel value of the image. Also, the toner is apt to attach to the pressure roller, etc. and a clean image cannot be obtained. Therefore, it is preferable to set the toner temperature to be not more than a temperature of a point D which is higher by about several tens centigrade than the point C from which the temperature goes into a fluidization region. Namely, in the case of color printing, the temperature range between the points C and D is preferred as a color fixing region. It is a matter of course that if the temperature is in the fluidization region and in the color printing region, monochrome printing can be carried out. However, as the temperature is higher, a grade of printing is lowered, which leads to energy loss and is not preferred.

Therefore, in the heating section 1, the toner is heated until it is in a softened state or in a fluidized state (being suitable for a color fixing region), depending on kind of printing. The fixing in the pressing and conveying section 2 is characterized by adhering the toner pressing while decreasing the toner temperature to a temperature where the toner is in a softened state and is easily impregnated between the fibers or a temperature where the toner is in a fluidized state and the toners having different colors are mixed and impregnated between the fibers.

Low temperature fixing of the toner 42 has progressed because of a demand for processing at a higher speed. Also it is necessary to consider not only printing of characters but also printing of an image on an entire surface of a recording medium. When, for example, an acryl-styrene resin is used as a component for the toner, in the case of a 2 μm thickness, 1.4 of a specific heat and 0.126 g per one A4 size recording medium, an amount of heat required for the toner is 17.6 J/100° C. Meanwhile, in the case of A4 size plain paper of a 70 μm thickness, 1.25 of a specific heat and 4.2 g, an amount of heat required for the paper is 525 J/100° C. Also from this point of view, it is very effective to incline a fixing device for effective use of heat like the fixing method of the present invention, and increase in the number of heating substrates will enable fixing of 60 sheets or more per minute.

In the example shown in FIG. 1A, the heating section 1 is designed to be heated with the first heating substrate 10a provided on the back surface of the recording medium 41 (the surface reverse to the toner-transferred surface) and the second heating substrate 10b provided at the front surface side of the recording medium 41 (the surface having a toner transferred) apart from the recording medium 41. However, the heating substrates need not to be provided on both sides, and may be provided on either side thereof. In the case of providing the heating substrate on either side of the recording medium, preferred is the first heating substrate 10a provided on the back surface of the recording medium 41 (the surface reverse to the toner-transferred surface). This is because the heating can be carried out by bringing the first heating substrate 10a into direct contact with the recording medium 41, and since the temperature of the recording medium 41 is elevated first, moisture contained in the recording medium 41 is easily evaporated. Further, since the toner 42 is heated from the recording medium 41 side, the temperature of the toner is elevated firstly from its recording medium 41 side, and therefore, the toner coming into contact with paper as the recording medium 41 will be in a fluidized state earlier and the toner is easily impregnated between the fibers of the paper.

On the other hand, as explained later, when the toner is heated from the toner-transferred surface side by means of the second heating substrate 10b, as shown in FIG. 1A, there is an advantage that the third heating substrate 10c can be used in combination. The first heating substrate 10a is disposed so that a surface of a protection layer 17 explained infra comes into contact with the back surface of the recording medium 41. The first heating substrate 10a is disposed at a fixed position, and the recording mediums 41 are carried in order. Therefore, if the first heating substrate 10a is disposed in contact with the recording medium 41, the both slide with each other, but are not pressed with each other. Further, the recording medium 41 comes into contact with the heating substrate on the back surface of the recording medium 41 opposite to the toner-transferred surface, and no toner 42 is attached thereto. Therefore, there is no problem at all. The protection layer 17 can be a thin sub-substrate such as ceramic, and durability is improved.

In the case of heating from the back surface side of the recording medium 41, as shown in FIG. 2D showing an example of a structure of the heating substrate 10 to be explained later, it is preferable to employ a suction structure such that through-holes 19a are provided on the first heating substrate 10a, and a suction tool for suction from the back surface of the first heating substrate 10a (the surface on the opposite side of the recording medium 41) is provided. This is because the recording medium 41 can be brought into contact with the first heating substrate. While the detail of this first heating substrate 10a is explained below, instead of providing the through-holes, thin grooves 19b may be formed on the surface thereof and a suction tool may be provided for evacuation of the inside of the grooves from the side surface of the first heating substrate 10a, or as shown in FIG. 2F, the first heating substrate 10a may be divided into plural pieces and suction tools may be provided on the clearances between the divided portions. In short, it is preferable that the recording medium 41 comes into close contact with the first heating substrate 10a with the suction structure using the through-holes or the grooves and the suction tool. In addition, this suction is conducted to such an extent to generate a state of pressure reduction, and so strong suction as to inhibit the conveying of the recording medium 41 is not necessary.

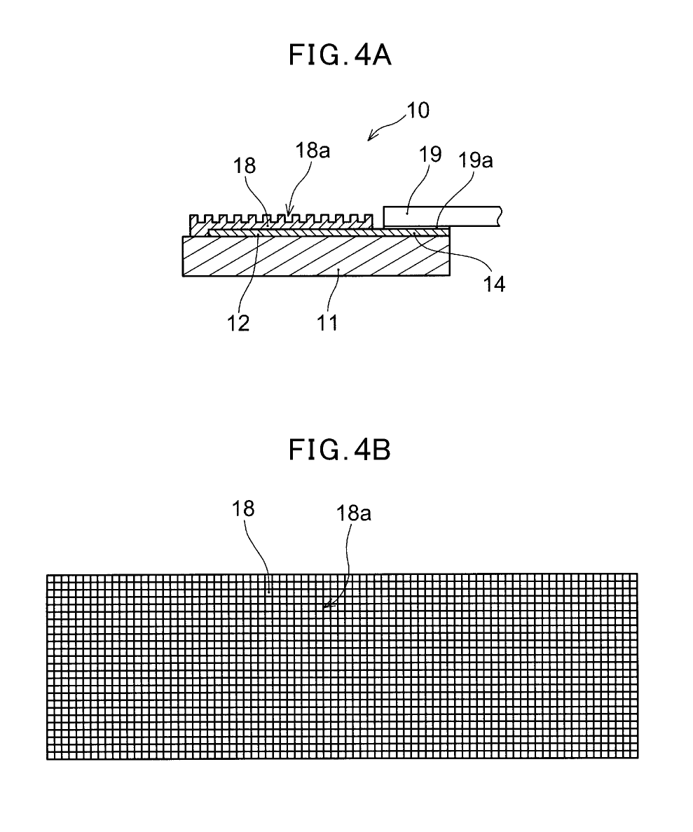

The second heating substrate 10b is disposed at the side of the toner-transferred surface of the recording medium 41 in the heating section 1 and is separated from the recording medium 41. Namely, the second heating substrate 10b is configured to be capable of heating the toner 42 without coming into contact with the toner 42 transferred on the recording medium 41. In other words, this second heating substrate 10b is so designed as to heat the toner 42 with radiation heat from the second heating substrate 10b but not by contact with the recording medium 41. Therefore, the toner-transferred surface of the recording medium 41 is not rubbed with the second heating substrate 10b, and a part of un-fixed toner 42 is not peeled off. From this point of view, it is preferable that the second heating substrate 10b has a structure enabling heat radiation to be easily emitted from its surface. For example, as shown in FIGS. 4A and 4B, it is preferable that the second heating substrate 10b has a structure enabling heat radiation to be easily increased by forming a heat radiation layer 18 made of a material having good heat radiation or by forming an uneven surface 18a on the layer 18.

For example, it is preferable that the second heating substrate 10b has a structure allowing heat radiation to be easily emitted by forming thereon a heat radiation layer made of a material having good heat radiation such as black alumite or glass and by forming an uneven surface of a width of from about 10 to 50 μm and a depth of from about 10 to 50 μm.

Specifically the heat radiation layer is formed by applying a paste mainly comprising a mixture comprising ruthenium oxide (RuO₂) and alumina (Al₂O₃) similarly to the heating element 12 (in the heating element 12, Ag is further mixed to adjust a resistance value) by printing for sintering. Therefore, before the paste has been hardened completely, by pressing the above-mentioned convex/concave structure or the like onto the paste, an uneven surface is formed and thus, a desired rough surface can be formed.

Further, it is known that an amount of heat radiation of an object is proportional to a value of (emissivity)×(the fourth power of an absolute temperature of an object surface (K⁴)). Therefore, it is preferable to increase a surface temperature of the heat radiation layer 18 in order to increase an amount of heat radiation. From this point of view, it is preferable to concentrate as much heat as possible from the heating element 12 on the heat radiation layer 18 without releasing the heat. Therefore, as mentioned above, it is preferable to form a heat insulating layer, which is not shown in the drawing, between the heating element 12 and the insulating substrate 11 so that transmittance of the heat generated by the heating element 12 to the insulating substrate 11 is reduced as far as possible. However, as mentioned above, in the case of common use with the third heating substrate 10c, heat transmission to the insulating substrate 11 side is necessary, and so it is not preferable to dispose the heat insulating layer between the heating element 12 and the insulating substrate 11.

Further in the example shown in FIG. 1A, the third heating substrate 10c for heating the pressure roller 21 is provided. In the example shown in FIG. 1A, the third heating substrate 10c is used in common with the second heating substrate 10b. The end face of the insulating substrate 11 of this third heating substrate 10c is cut obliquely so as to be pressed onto the outer peripheral face 21a of the pressure roller 21. Therefore, the heat of the third heating substrate 10c is transmitted to the outer peripheral face 21a of the pressure roller 21 via the insulating substrate 11, and the toner 42 on the recording medium 41 can be pressed by the outer surface 21a of the pressure roller 21 of an elevated temperature. Therefore, the toner 42 having been heated in the heating section 1 to be formed into a softened or fluidized state does not decreased its temperature rapidly when coming near the pressure roller 21 and is not pressed in a state of being about to be solidified. Thus the toner 42 can be pressed in a softened or fluidized state. In this case, since decrease of the temperature of the toner 42 begins from its surface side, the temperature of a surface of the toner 42 becomes near a temperature in its solid region, and the toner does not adhere to the pressure roller 21. As a result, the fixing can be conducted more securely. In addition, as shown in FIG. 1A, since the end face of the insulating substrate 11 of the third heating substrate 10c is cut obliquely, the toner can be heated just before the pressing of the recording medium 41 by the pressure roller 21, thereby enabling effective use of the heating.

This third heating substrate 10c is not an essential one. On the other hand, as described below, the third heating substrate 10c is provided with a resistive element for temperature measurement, and a temperature of the outer periphery of the pressure roller 21 is measured via the third heating substrate 10c. In the case of continuous printing, there is a case where a temperature of the outer periphery of the pressure roller 21 coming into contact with the heated toner 42 is elevated, and no heating by the third heating substrate 10c is necessary, or there may be a case where cooling by air cooling or the like is necessary. The structure of the first heating substrate 10a itself, and essential portions of the second heating substrate 10b, the third heating substrate 10c and the fifth heating substrate 10f are nearly the same as the structure of so-called a ceramic heater where a heating element is formed on one surface of conventional ceramic substrate. Therefore, an example of a common heating substrate 10 is described below in reference to FIGS. 2A to 2C.

A purpose of the pressing and conveying section 2 is to cohere the toner with the toner temperature having been lowered. However, if the temperature decreases too rapidly, the pressing cannot be carried out surely. Therefore, it is preferable to carry out heating to a certain extent lest the temperature should decrease rapidly. Thus, the pressing of the recording medium 41 is carried out at a temperature equal to or lower than the temperature of the toner in the softened or fluidized state in the heating section 1, namely at a temperature lower than that of the fluidization region. In other words, the pressing is done at a temperature lower than the temperature for heating in the heating section 1. Therefore, when the pressure roller 21 is heated and its temperature becomes too high by continuous printing, as mentioned above, there is a case where the heating is not done and cooling (air cooling) is conducted.

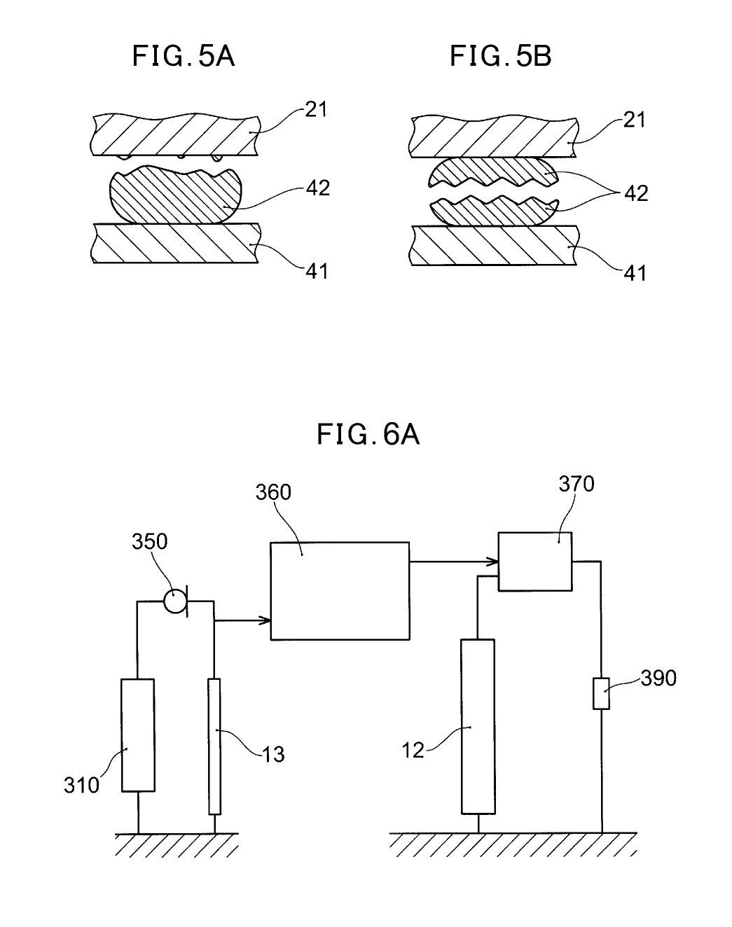

In this pressing and conveying section 2, when the temperature of the pressure roller 21 is not more than the temperature of the softened toner, as shown in FIG. 5A, the toner hardly adheres to the pressure roller 21, and the toner temperature at the recording medium 41 side is higher than the temperature at the pressure roller 21 side and the toner is in a state of being in close contact with the recording medium 41. In FIG. 5A, some of the toner 42 adheres to the pressure roller 21, and the surface of the toner 42 is illustrated exaggeratingly as if it was damaged. However, actually the toner 42 surface is hardly injured and a glossy fixed surface is obtained. While the pressure roller 21 has a circular outer shape, enlarged view thereof in FIGS. 5A and 5B is nearly plane. On the other hand, when the temperature of the pressure roller 21 is the temperature of the fluidization region, the toner contacting with the pressure roller 21 is in a fluidized state. Therefore, the pressure roller 21 is apt to adhere to the toner 42. Meanwhile, adhesion of the recording medium 41 to the toner 42 is also good since the toner 42 is in a fluidized state. On the contrary, since cohesion of the toner 42 is weak, as shown in FIG. 5B, the toner 42 is separated into about a half size at the recording medium 41 side. Therefore, it is preferable to keep the pressure roller 21 at a temperature equal to or lower than the temperature of the toner in the softened state. The outer surface of the pressure roller 21 is preferably subjected to treatment so as to have flexibility, abrasion resistance, adhesion preventing property and the like.

From the viewpoint mentioned above, in the pressing and conveying section 2, the heating from the back surface side of the recording medium 41 is preferable rather than elevation of the temperature of the pressure roller 21. Therefore, as shown in FIG. 1B and in the plan view of FIG. 2D illustrating the first heating substrate 10a, it is preferable that the first heating substrate 10a is extended to the pressing and conveying section 2 and on the extended portion of the first heating substrate 10a, no heating element 12 is formed. Namely, in FIG. 2D, an upper side in the vertical direction is a downstream side of the recording medium 41, and the portion where the abrasion resistance layer 20 is formed is a portion opposed to the pressure roller 21. The heating element 12 is not provided on this portion and therefore, the temperature thereof does not become so high. However, due to transmission of the heat of the insulating substrate 11 heated at the portion provided with the heating element 12, the temperature of the abrasion resistance layer 20 is increased. In the pressing and conveying section 2, heating with such heat is preferable since the toner does not become a fluidized state and a sudden temperature drop can be prevented.

FIG. 3B shows a relation of conditions of the toner 42 (a temperature and viscoelasticity thereof) to a position of the recording medium 41 during the process from the transferring, via the heating section 1 and the pressing and conveying section 2, up to the completion of the fixing. Namely, in FIG. 3B, a point F indicates a temperature elevated by heating with the fifth heating substrate 10f, and a state of the toner having been transferred (a solid region). At a point G, the heated toner reaches to a glass transition point Tg to become a softened state. The toner is further heated in the heating section 1, and the temperature thereof is increased gradually and viscoelasticity thereof decreases. At a point H, a part of the toner is fluidized. With respect to a temperature at which the toner in the softened state starts fluidization, a change to the fluidization does not occur at a time, and a phase change advances gradually and the phase change arises during a constant temperature range “i”. Then at a point I, the entire toner 42 becomes in a fluidized state. As mentioned above, even this fluidized state is not preferable for the printing if the toner temperature is so high. Therefore, the toner temperature is controlled to keep the temperature J before reaching the point D in FIG. 3A as mentioned above. At a point K, by pressing the recording medium by the pressure roller 21, the temperature of the toner 42 suddenly lowers and at a point L, the toner becomes in a completely softened state and the toner temperature lowers slowly. At a point M, the recording medium is released from the pressure roller 21 completely, and thereafter, is cooled while being carried and reaches to the temperature F at which the recording medium can be handled easily. A period of time “m” from the point K to the point M is a time period where the recording medium is pressed with the pressure roller 21.

For a heating/pressing roller used for conventional fixing devices, a rubber roller which is easily heated is used, and the pressing is carried out while heating. However, in the present invention, heating is not intended, and the pressing is rather carried out while cooling. Therefore, it is preferable that at least the outer surface of the pressure roller 21 is formed from a material being easily separated from the toner, having releasability and assuring that the toner is not adhered to the pressure roller 21.

Specifically, the pressure roller 21 is made of a relatively hard insulating material such as plastic, and a fluorine-containing resin film for prevention of adhesion of the toner is formed on an outer surface 21a. In the heating of the pressure roller 21, an amount of heat for allowing the toner 42 to be changed into a softened state or a fluidized state is not required, and the heating is done lest the temperature of the toner 42 in the softened state or the fluidized state should lower suddenly, thereby solidifying the toner. Therefore, the toner temperature needs not to be so high, and as shown in FIG. 1B, the heat transmitted via the insulating substrate 11 of the heating substrate 10a suffices. However, as shown in FIG. 1B, in the case where the third heating substrate 10c is used exclusively for heating of the pressure roller 21, it is possible to provide the third heating substrate 10c so that the pressure roller 21 comes into contact with the protection layer 17 but not the insulating substrate 11. It is a matter of course that the pressure roller 21 can be heated by bringing the pressure roller 21 into contact with the back surface of the substrate 11 but not the side of the protecting film 17 of the third heating substrate 10c.

As mentioned above, the purpose of the pressure roller 21 is to press the toner 42 changed into a softened state or a fluidized state in the heating section 1 on the recording medium 41 in order to impregnate the toner 42 into the recording medium 41. However, if the temperature of the toner 42 on the recording medium (paper) 41 carried to the pressing and conveying section 2 lowers suddenly, the toner may not be impregnated sufficiently into the recording medium 41 only by pressing. In consideration of such a case, it is preferable that the temperature of the pressure roller 21 is high enough to a certain extent lest the toner temperature should lower suddenly. Therefore, in the example shown in FIG. 1A, the third heating substrate 10c (to be used in common with the second heating substrate 10b in the example shown in FIG. 1A) is pressed to the pressure roller 21 so that the end face of the insulating substrate 11 comes into contact with the outer surface 21a of the pressure roller 21. It is preferable that a contacting portion of the pressure roller 21 with the third heating substrate 10c is located at a portion (a position which reaches a pressing point by the rotation of the pressure roller 21) at an upstream side (at the side before reaching the contacting portion) as near as possible to the portion where the pressure roller 21 comes into contact with the recording medium 41. This is because it is preferable to bring the pressure roller 21 into contact with the recording medium 41 before the heat transmitted from the third heating substrate 10c is released. However, for the use in common with the second heating substrate 10b, the contacting portion is decided in accordance with the position of the second heating substrate 10b.

As mentioned above, when the transferred toner 42 is heated, its viscoelasticity decreases gradually as shown in FIG. 3A, and the toner 42 is easily impregnated into the recording medium 41. When the recording medium 41 is pressed, the toner 42 impregnated between the fibers of paper is cohered and is hardly peeled off. As a result of the pressing of the toner 42, an un-fixed toner 42 is pressed to be the fixed toner 43. As a result, the surface of the toner 43 is flattened and a clear printed surface can be obtained.

In the transfer section 3, in the same manner as in usual electrophotographic printer, while rotating a photoconductor drum 31 being an example of a photoconductor so that the photoreceptor drum 31 passes through a cleaning section 32, a electric charge removing section 33, an charging section 34, an exposure (optical writing) section 35 and a developing section 36, optical writing is conducted at the exposure section 35 using laser beam or LED light to form an electrostatic latent image on the photoconductor drum 31, and then the toner 42a is adhered to the electrostatic latent image on the photoconductor drum 31 at the developing section 36 to be developed and form a visible image. Then, by transferring the toner 42a from the photoconductor drum 31 to the recording medium 41 with an electric force using a transfer device 37, a photographic image is formed on the recording medium 41. The toner 42a is prepared by mixing various pigments to a resin. This recording medium 41 is then carried via the heating section 1 and the pressing and conveying section 2 in order, thereby fixing the image of the transferred toner 42. In the case of color printing, the any color toners 42 of black (K), cyan (C), magenta (M) and yellow (Y) are transferred in order, and after the transferring the toners of plural colors, the toners are heated in the heating section 1 to be changed to a softened state and then into a fluidized state, followed by pressing. If the toner is carried for a long period of time in a state of being transferred, it may be released and may float in the air. Therefore, it can be considered that soon after the transferring of the toner of each color, the toner is fixed temporarily.

In the transfer section 3 shown in FIG. 1C, the transfer section 3 is not independent as a transfer device having a conventional photoconductor and a separate charger or a transfer roller, and the insulating substrate 5 (this portion can also be said to be a heating substrate), on which a heating element for heating at the heating section 1 is formed, is continuously formed up to the transfer section 3, and an electrode 39 for transferring is provided on the surface of the insulating substrate 5, thus forming the transfer section 3. Then the toner 42a developed on a photoconductor 31 by a high electric field applied to the electrode 39 for transferring is attracted toward the recording medium 41 side and transferred onto the recording medium 41. In other words, the transfer section 3 is characterized in that the transfer device is not provided independently, and the electrode 39 for transferring is provided on the surface of the extended part of the insulating substrate 5 as a heating substrate (including the case where a plurality of insulating substrates are connected).

In other words, as shown in FIG. 2G, the insulating substrate 11 of the heating substrate used for heating of the heating section 1 is extended to the transfer section 3, and the electrode 39 for transferring is formed on the surface of the insulating substrate 5. The insulating substrate 5 is formed continuously (including the case of the substrates being connected to each other) up to the pressing and conveying section 2 and is used as a support 22 of the pressure roller 21 at another end thereof. The insulating substrate 5 is continuously formed from the heating section 1 toward the both sides of the transfer section 3 and the pressing and conveying section 2, thereby allowing the heat generated by heating in the heating section 1 to be transmitted via the insulating substrate 5 to the transfer section 3 and the pressing and conveying section 2, to heat the recording medium 41 on the electrode 39 for transferring and the recording medium 41 on the support of the pressing and conveying section 2. As a result, the transferred toner 42 is soon subjected to pre-heating for the heating, and the toner 42 can be adhered to the recording medium 41 by pressing without suddenly lowering the temperature of the toner 42 changed into a fluidized state by heating. Namely, the toner is heated before heating in the heating section 1, and therefore, even if the toner is not changed into a softened state before the heating section 1, the toner is sufficiently preheated and is changed into a softened state or a fluidized state immediately by heating in the heating section 1. Further, in the pressing and conveying section 2, the temperature of the toner 42 does not lower suddenly, the toner is pressed in its softened state, and the toner is stuck to the recording medium 41 without adhesion of a part of the toner 42 onto the pressure roller 21, etc., namely without injuring the toner 42.

As mentioned above, it is necessary that the insulating substrate 5 is formed continuously from the heating section 1. The term “continuously” does not mean, as mentioned above, that the insulating substrate 5 is not necessarily integrated. The insulating substrates 5 may be formed separately for the heating section 1, the transfer section 3 and the pressing and conveying section 2, and then connected with an adhesive or by abutting to each other. Namely, the insulating substrates 5 may be connected so as to enable sufficient heat conduction to be obtained. The entire insulating substrate 5 is not necessarily made of an insulating material, and at least surfaces thereof, on which the heating element 12 and the electrode 39 for transferring are provided, may be made of an insulating material. Therefore, the insulating substrate may be a metal plate having an insulating film formed thereon. With such configuration, the insulating substrate 5 is excellent in thermal conductivity.

The insulating substrate 5 may be one which is used as an insulating substrate of the heating substrate to be used in the heating section 1. Namely, unlimited example of a usable insulating substrate is one having excellent thermal conductivity and made of alumina or the like. A shape thereof is preferably rectangular, but is not limited thereto. A width W thereof (see FIG. 2G; a length of the insulating substrate 5 in a vertical direction with respect to a paper plane of FIG. 1C) is preferably the same as the width of the recording medium 41. Even if the width is smaller than that, there is no problem if a plurality of insulating substrates 5 can be arranged in the direction of the width W. A length L of the insulating substrate 5 (see FIG. 2G; a length in the travelling direction of the recording medium of FIG. 1C) is, for example, about 5 cm. An alumina substrate having a thickness of, for example, about 0.6 mm can be used. The insulating substrate 5 is formed so as to be extended from the heating section 1 up to the transfer section 3 and the pressing and conveying section 2, and is disposed at the back surface side of the recording medium 41. However, as mentioned above, the insulating substrate 5 is not necessarily one integrated completely, and for example, the insulating substrates are produced separately for the heating section 1, the transfer section 3 and the pressing and conveying section 2 and may be connected using an adhesive or the like. The point is that these substrates are continuously connected and there is sufficient heat conduction between them.

As described below, the heating element 12, etc. are formed on the surface of the insulating substrate 5, and a protection layer such as a cover substrate is formed on the surface of the insulating substrate. One or more of convex(s) and concave(s) are formed on the surface of the cover substrate, and further suction holes and/or suction grooves are formed on the insulating substrate 5 and the protection layer thereon, and by suction of the recording medium 41, a contact pressure at the convex portions is increased, which enables heat conduction from the heating element 12 to be enhanced more. Such convex and concave are formed, for example, in a shape of chevron (Quonset hut shape; D-shaped) in a height of a portion of the heating element of about 0.2 to 0.3 mm per a 50 mm length of the insulating substrate 5. Examples of a method for forming such convex include a method of forming a plurality of insulating substrates 5 having a D-shaped surface and connecting the substrates, a method of when forming a glazed layer (heat-insulating layer), which is not shown, on the insulating substrate 5, increasing a thickness of a center part of the glazed layer before forming the heating element 12, a method of increasing the thickness of the heating element 12 or the thickness of the protection layer 17, and the like methods. For the suction of the recording medium, it is possible to use an electrostatic chuck method for electrostatic suction by forming an electrode. Anyway, it is preferable to form a convex by swelling a part of the heating element 12.

In the transfer section 3, as mentioned above, the electrode 39 for transferring is formed on the surface of the insulating substrate 5. The electrode 39 for transferring is one formed by adhering a stainless alloy to the insulating substrate 5 with an elastic adhesive, and the surface and corner portions thereof are finished smooth with a metal film of about 30 to 50 μm thick and about 8 mm wide. A voltage of, for example, about 500 V to 1000 V which is reverse potential to a potential of the charged toner 42a is applied via an electrode terminal not shown in the drawing for electrically charging the recording medium 41 to transfer the charged toner 42a from the surface of the photoconductor 31. If an electric potential of the electrode 39 for transferring is too high, the transferred toner 42 is charged with a reverse electric potential, and is attracted to an electric potential of the photoconductor 31 when the recording medium 41 separates from the transfer section 3. Therefore, in the case where the recording medium 41 is not a continuous sheet of paper, but cut paper of A4 and B5 sizes, since the recording medium 41 is wound on the photoconductor 31, it is necessary to set the toner 42 to have an electric potential which allows the recording medium 41 not to be wound on the photoreceptor by separating the toner 42 from the photoconductor 31. The electrode 39 for transferring can also be fixed to the surface of the insulating substrate 5 by increasing its width to be extended toward the upstream side of the transfer section 3 or by connecting separate electrode parts on the insulating substrate. In the case where the fifth heating element 12e described below is provided, the electrode 39 for transferring can be provided on the surface thereof via an insulating layer.

In this embodiment, the substrate, on which the electrode 39 for transferring of the transfer section 3 is disposed, is formed by extending the insulating substrate 5 of the heating section 1 having the heating element 12 thereon or is connected to the insulating substrate of the heating section 1. Therefore, also in the transfer section 3, the temperature of the insulating substrate 5 is increased and the recording medium 41 is also heated. As a result, since the transferred toner 42 is heated immediately after the transferring, it is easily adhered to the recording medium 41, thereby not only inhibiting scattering of fine powders of the toner 42, deterioration of an image and winding of the recording medium 41 on the photoconductor 31 but also reducing a period of time for changing the toner 42 into a softened state or a fluidized state. As shown in FIG. 2H referred to below, two electrodes 39, 39b for transferring of the transfer section 3 may be formed. In that case, when different voltages are used on the two electrodes, the electrode 39b at the downstream side can be used for preventing winding of the recording medium 41 on the photoconductor 31, namely can be used also as a separate charging electrode. It is preferable to provide an elastic body on its surface. It is also possible to bring the recording medium 41 into slightly contact with the photoconductor 31 by lifting up the leading end of the insulating substrate 5 at its upstream side by means of a spring to allow the insulating substrate 5 to be rotated using the insulating substrate 5 at the pressing and conveying section 2 side as a supporting point. The structure of the transfer section 3 at the photoconductor 31 is as described above.

In the example shown in FIG. 1A, the recording medium heating section 4 is provided upstream of the transfer section 3, and the fifth heating substrates 10f for heating the recording medium 41 are provided so as to come into contact with both surfaces of the recording medium 41. The fifth heating substrates 10f need not to be provided on both surfaces of the recording medium 41, and may be provided on either side of the recording medium 41. It is particularly preferable to provide the fifth heating substrate, on the face (surface) of the recording medium where the toner 42 is transferred. The fifth heating substrate may be provided only on the back surface side of the recording medium 41. This is because in the case of a thin recording medium, the heating can be made immediately. In the case of providing on the back surface side, it is possible to integrate the fifth heating substrate with the first heating substrate 10a. As mentioned above, in the case where the recording medium 41 is paper, it is apt to absorb moisture, and if moisture is contained inside the recording medium 41, when the toner 42 is transferred and fixed to the recording medium, moisture is evaporated and an uneven surface arises on the surface of the toner 43. In the present invention, the heating section and the pressing and conveying section are configured to be separated, and therefore, this problem is resolved to a large extent. In order to resolve this problem surely, it is preferable to heat the recording medium 41 before transferring the toner 42 to evaporate moisture in the recording medium 41 beforehand.

The fifth heating substrates 10f can also be formed in the same manner as in the first heating substrate 10a, and as shown in FIG. 1C, in the case of the insulating substrate 5 being formed continuously through the heating section 1, the transfer section 3 and the like, it is possible to further extend the insulating substrate 5 toward the upstream side and form the fifth heating element 12e on the surface of the extended part of the insulating substrate 5. The detail of such configuration is explained later. The purpose of the fifth heating substrates 10f is not for changing the toner 42 into a softened state or a fluidized state but only for evaporating moisture of the recording medium 41. Therefore, a smaller power suffices as compared with the first heating substrate 10a.

From the viewpoint of heating the recording medium 41 for evaporating moisture and effectively heating each heating part, for example, as shown in FIG. 1A, it is preferable to form a cover case 7 for integratedly enclosing, within a minimum space, the recording medium heating section 4, the heating section 1 for heating the toner 42, the pressing and conveying section 2 and the discharged paper accumulating section 6 for accumulating the discharged recording medium 41, and further to incline a conveying path of the recording medium 41 so that the transfer section 3 side is higher than the pressing and conveying section 2. Also, a first opening 7a is formed at the side of the discharged paper accumulating section 6 and a second opening 7b is formed at the side of the recording medium heating section 4, and as a result, an air flow 7c is formed inside the cover case 7. Namely, since the cover case 7 is inclined, the heated air goes upward, and therefore, the air flow 7c is formed from the first opening 7a toward the second opening 7b. As a result, the air flow 7c contributes to the heating in the recording medium heating section 4, the heating section 1 for heating the toner 42, and the pressing and conveying section 2. The air flow 7c is preferable also from the viewpoint of preheating the recording medium 41 before it reaches the heating section 1.

From the viewpoint of effective use of heat, it is preferable that an angle of the inclination of the fixing device with respect to a horizontal plane is as large as possible. However, since the transferred toner 42 is only attached to the surface of the recording medium 41 such as paper, if the inclination is too large, the toner 42 may slip down. The same may arise in the case of heating until the toner 42 becomes a fluidized state in the heating section 1. From this point of view, a smaller inclination is preferred. In consideration of the above-mentioned points, the inclination is preferably from 20° to 60°, further preferably from about 30° to 45°. As mentioned above, since the fixing device is enclosed with the cover case 7 and is inclined, the recording medium 41 can be dried even with weak heat in the recording medium heating section 4, and the toner 42 can be heated to be changed into the softened state or the fluidized state in the heating section 1, which as a whole, can reduce energy consumption, and contributes to prevention of global warming.

In the embodiment shown in FIG. 1A, the recording medium 41 is illustrated as a continuous band-like one, however, actually there is a case where the recording mediums 41 are sheets of paper cut to a certain size such as A4 size, B5 size or a card size and are fed continuously or a case where the recording medium is a continuous rolled paper, and in the case of continuous paper, the paper is wound up by means of a roll or is folded up in the discharged paper accumulating section 6. Therefore, at the most downstream side, the fixed paper (recording medium) 41 is delivered to the discharged paper accumulating section 6 and accumulated there, and heat is also accumulated in the discharged paper accumulating section 6. Though the fixed discharged paper 41 has been cooled at the pressing and conveying section 2, it has a temperature so higher than room temperature and radiates heat. In this embodiment, this heat radiated in the section 6 is used effectively for energy saving. For that purpose, the fixing device including the discharged paper accumulating section 6 not only is covered by the cover case 7 which is formed so as to transmit the heat toward the transfer section 3 side, but also is so installed that the recording medium 41 is inclined during the conveying thereof. This embodiment is preferred from the viewpoint of effective use of heat and protection of global environment, namely prevention of global warming.

The above-mentioned first to fifth heating substrates 10a to 10f are of the same structure and are explained simply as a heating substrate 10. The heating substrate 10 has the same structure as conventional heating head which is used for recording and erasing of a card and the like. For example, FIG. 2A shows a plan view of a basic heating substrate 10 from which a protection layer (sheet) 17 has been removed, and FIG. 2B is a view illustrating B-B cross-section of FIG. 2A, which shows that the protection layer (cover plate) 17 is formed. Namely, the heating element 12, the resistive elements 13 (13a, 13b) for temperature measurement (of the substrate), the electrodes 14 (14a, 14b, 14c), the temperature measurement terminals 15 (15a to 15e), and the like are formed on the insulating substrate 11, and the protection layer 17 is formed thereon. In addition, the heating element 12 and the resistive elements 13 for temperature measurement are connected to the electrodes 14 and the temperature measurement terminals 15 by means of the connecting conductors 16, respectively. As shown in FIG. 4A, leads 19 are connected to the electrodes 14 and the temperature measurement terminals 15 (not shown in FIG. 4A).

More specifically, the heating substrate has a structure such that the heating element 12 and the resistive elements 13 (13a, 13b) for temperature measurement are provided on one surface of the insulating substrate 11 made of ceramic such as alumina. The shapes and arrangement thereof may be selected optionally. In the embodiment shown in FIG. 2A, for example, a linear band-like heating element 12 is formed along one side in the lengthwise direction of the rectangular insulating substrate 11. The length of the insulating substrate 11 in its lengthwise direction is not less than 50 mm, and is decided according to the width of the recording medium 41 (a dimension of the recording medium 41 in the vertical direction with respect to a paper plane of FIG. 1A). When the size of the recording medium 41 is larger, the size of the heating substrate can be matched to the width of the recording medium 41 by increasing the length of the insulating substrate 11 or arranging a plurality of heating substrates 10 in the lengthwise direction thereof. The width of the insulating substrate 11 (a dimension in the direction vertical to the extending direction of the heating element 12) is, for example, about 12 mm. For example, an alumina substrate having a thickness of about 0.6 mm is used.

In the case where the heating substrate 10 is formed using one long insulating substrate 11, the heating substrate is controlled to enable the temperature of the entire insulating substrate 11 to be always uniform by forming a plurality of electrodes 14 and temperature measurement terminals 15 in the midst of the heating elements 12 and the resistive elements 13 for temperature measurement to allow a voltage to be applied dividedly or allow temperatures of each region of the insulating substrate 11 to be set independently.

In the embodiment shown in FIG. 2A, two resistive elements 13a, 13b for temperature measurement are formed but the number of resistive elements for temperature measurement is not limited thereto. If the temperature of the insulating substrate 11 is too low, the toner 42 transferred on the recording medium 41 is not changed into a softened state or a fluidized state and is not fixed sufficiently, and if the temperature of the insulating substrate 11 is too high, the toner 42 becomes an excessively fluidized state and is attached to the pressure roller 21, thereby leading to generation of a phenomenon of toner offset. Therefore, it is necessary to accurately control the temperature of each region of the insulating substrate 11. So, it is preferable to form as many resistive elements 13 for temperature measurement and temperature measurement terminals 15 as possible.

The heating element 12 is formed by selecting, for example, Ag, Pd, RuO₂, Pt, metallic oxide, glass powder and the like, mixing them to make a temperature coefficient, resistance value and the like most suitable, forming the mixture into a paste-like shape, and then subjecting the mixture to printing and baking. A sheet resistance value of the heating element 12 formed by the baking can be changed by an amount of a solid insulating powder. The resistance value and the temperature coefficient can be changed by a ratio of the amounts of mixed components. A similar paste-like mixture prepared by increasing a ratio of Ag and decreasing a ratio of Pd is used as a material for the conductors (electrode 14, temperature measurement terminal 15, connecting conductor 16), thereby making it possible to form the conductors by printing in the same manner as in the heating element 12. There is a case where the mixing ratios need to be changed depending on a working temperature of the heating element in relation to terminal connection. When the ratio of Ag increases, the resistance value can be decreased. A positive higher temperature coefficient of the resistance of the heating element 12 is preferable, and it is preferable to use a material of from 1000 to 3500 ppm/° C. Further, though it is not shown in the drawing, the electrodes are provided at suitable positions along a current flowing direction of the heating element 12, thereby enabling a voltage to be applied partly and enabling the respective temperatures of the heating elements to be changed.

The positive higher temperature coefficient of the resistance means that if the temperature is elevated, increase of the resistance value is large. Therefore, by measuring the resistance value in a state of heat generation, detection of actual heat generation temperature can be made easily accurately from a deviation from a reference resistance value, and a deviation from the desired heat generation temperature can be corrected easily by adjusting an effective applied power. In the case of a fixing device, commercial AC power source is used as a power source for the heating element 12 in many cases, and there are many cases where the commercial AC power source is used as it is, for example, in the form of half-wave rectification or full-wave rectification without changing to a direct current. In that case, an effective value is controlled with a pulsating current as it is. It should be noted that a two-way thyristor (brand name: TRIAC) is used for control, and the control is done using an effective value. The temperature measurement is also done using an effective value, and the temperature control is done using TRIAC. Further, when the temperature coefficient of the resistance is positive, in the case of excessive elevation of the temperature, the resistance value increases, a current value decreases, an amount of heat generated decreases, and the temperature reaches to a saturated state earlier. Therefore, temperature stability at high temperatures is excellent, and overheating due to thermal runaway can be prevented. In addition, a standard width of the heating element 12 may be set such that a given temperature is obtained according to application, and a plurality of heating elements 12 may be arranged in parallel.

Further, the electrodes 14 comprising a good electric conductor such as a silver-palladium alloy having a small palladium ratio or an Ag—Pt alloy are formed by printing at both ends of the heating element 12. As shown in FIG. 4A, the heating substrate has a structure such that a lead 19 is connected to the electrode 14 which is connected to a power source, thereby conducting electric power to the heating element 12. This power source may be either of DC or AC, or may be a pulse voltage. In the case of the pulse voltage, by changing its duty, an applied power can be controlled. Furthermore, in FIG. 2A, heating element 12 of about 4 mm wide is formed. However, the width of the heating element and the number of heating elements are not limited thereto and can be decided to obtain a desired temperature according to purposes.

Similarly to the heating element 12, the resistive elements 13 (13a, 13b) for temperature measurement are formed on the surface of the insulating substrate 11 in the vicinity of the heating element 12. It is preferable that the resistive elements 13a, 13b for temperature measurement are formed along the heating element 12 as shown in FIG. 2A. In the embodiment shown in FIG. 2A, two resistive elements for temperature measurement 13a, 13b having somewhat different lengths are formed apart from each other. The both ends of each of the resistive elements 13a, 13b for temperature measurement are connected to a pair of temperature measurement terminals 15 (15a, 15b; 15c, 15d). These temperature measurement terminals 15a-15d are also made of a material having good conductivity in the same manner as in the electrodes 14. Not only the pair of temperature measurement terminals 15a to 15d are formed at both ends of the resistive element 13 for temperature measurement, but also a temperature measurement terminal 15e is formed at the center part of the resistive element 13a for temperature measurement.

The resistive elements 13 for temperature measurement may be formed using the same material as in the heating element 12, however, a material having a large absolute value (%) of the temperature coefficient is preferred. The resistive elements 13 for temperature measurement are those which do not generate heat but detect the temperature of the insulating substrate 11 and allow the toner 42 to reach a softened state or a fluidized state. For example, a width of the resistive element for temperature measurement is 0.5 mm, and a length thereof is somewhat smaller than the heating element 12. An applied voltage of the resistive element for temperature measurement is as low as possible so as not to cause heat generation of the resistive element 13 for temperature measurement itself, and for example, about 5 V is applied thereto. Namely, since the resistive element 13 for temperature measurement is disposed directly on the insulating substrate 11, the temperatures of the both are nearly the same, and by measuring the resistance value of the resistive element 13 for temperature measurement, the temperature of the surface of the insulating substrate 11 can be known. Therefore, the temperature of the insulating substrate 11 for heating the recording medium 41 is adjusted so as to change the toner into a softened state or a fluidized state is obtained. Namely, generally the resistance value of the material of the resistive element for temperature measurement varies as its temperature varies, and therefore, the temperature of the resistive element for temperature measurement is measured by measuring variation of its resistance value. While the temperature detection means is described later, by detecting a voltage variation at both ends of the resistive element 13 for temperature measurement, a resistance value of the resistive element 13 for temperature measurement is detected, when a current is constant, and a temperature of the resistive element 13 for temperature measurement is obtained from the detected resistance value and a temperature coefficient (which varies depending on the material thereof and is known beforehand). When the temperature coefficient is larger, a measurement error can be minimized. In that case, the temperature coefficient may be either plus or minus.

The resistive element 13 for temperature measurement can be formed by printing or the like, and its material is not limited to the same one as that of the heating element 12, but is selected according to application. Namely, when a minute temperature difference is needed, it is possible to use a material having a different mixing ratio of Ag and Pd or a completely different material having a large temperature coefficient for the resistive element 13 for temperature measurement. The temperature measurement terminals 15 of the resistive element 13 for temperature measurement are also formed using a material having good conductivity and prepared by increasing a ratio of Ag and decreasing a ratio of Pd in the same manner as in the electrodes 14 of the heating element 12. The temperature measurement terminals 15 are not necessarily formed at the ends of the resistive element 13 for temperature measurement. For example, as shown in FIG. 2A, the temperature measurement terminal 15e may be provided at the center part of the resistive element for temperature measurement, or the temperature measurement terminals may be provided at the center parts of the respective resistive elements divided into two pieces. The positions of the resistive element 13 for temperature measurement and the temperature measurement terminals 15 are set according to the purpose and the size of the insulating substrate 11.

While in FIG. 2A, only outer periphery is shown by two-dotted line, the heating element 12, the resistive elements 13 for temperature measurement and the connecting conductor 16 are enclosed with the protection layer 17 as shown in the cross-sectional view of FIG. 2B. The protection layer 17 is preferably one having a large heat conductivity, and is formed from, for example, a hard glass film having a smooth surface. However, in the case where the surface of the third heating substrate 10c disposed opposite to the insulating substrate 11 comes into contact with the pressure roller 21 to heat the roller as shown in FIG. 1B and described later, a cover substrate comprising a thin ceramic substrate having a thickness being a half of a thickness of the insulating substrate 11 may be provided instead of the protection layer 17. Also in this case, a cover substrate is called the protection layer 17, too. The electrodes 14 and the temperature measurement terminals 15 are not covered and are exposed, and are connected to a lead which is not shown in the drawing. Though not shown in the drawing, from the viewpoint of power saving, it is preferable to insert a heat insulating layer such as a glazed layer between the heating element 12 and the insulating substrate 11.

In the embodiment shown in FIG. 2A, the electrodes and the measurement terminals are provided at both ends of the heating element and the resistive element for temperature measurement, respectively. However, it is possible to collect each one of the electrodes and the measurement terminals at the one side edge of the substrate by using a connecting portion 16 connected to the each one of the electrodes and the measurement terminals. One example thereof is shown in FIG. 2C. Namely, in the example shown in FIG. 2C, each of the heating element 12 and the resistive element 13 for temperature measurement is formed in parallel with each other, and further, a common conductor 16 is formed. This common conductor 16 is arranged side by side with the electrode 14 connected to one end of the heating element 12 and the measurement terminal 15. And the electrode 14 is connected to one end of the heating element 12, and the temperature measurement terminal 15 is connected to one end of the resistive element 13 for temperature measurement. And the common conductor 16 is connected to another end thereof. Other structure is the same as in FIG. 2A, and the same symbols are provided for the same portions, and explanations thereof are omitted.

FIG. 2D shows an example of a configuration of the first heating substrate 10a in the case where the extended part of the first heating substrate 10a is used as a support which is provided opposed to the pressure roller 21 and supports the pressure roller 21 via the recording medium 41. In this example, two each of the heating element 12 and the resistive element 13 for temperature measurement are formed. On the extended part opposed to the pressure roller 21, the heating element 12 is not provided, and an abrasion resistance layer 20 is formed. Even if the heating element 12 is not provided, there is a temperature rise of the recording medium 41 to a certain extent due to heat conduction via the insulating substrate 11, which is advantageous since a sudden temperature drop of the insulating substrate 11 at the pressing and conveying section 2 can be prevented. Further, in this example, as mentioned above, a suction apparatus is provided to allow the recording medium 41 to come into close contact with the first heating substrate 10a. Namely, in the example shown in FIG. 2D, through-holes 19a and grooves 19b connecting the through-holes are formed between the heating element 12 and the resistive element 13 for temperature measurement. A suction tool which is not shown in the drawing is provided over the through-holes 19a at the back surface side of the insulating substrate 11. The inside pressure of the through-holes 19a and the grooves 19b becomes negative by suction of air therefrom, and the recording medium 41 passing over the heating substrate is stuck thereto. The suction apparatus is so configured as mentioned above. Namely, the recording medium 41 is carried while coming into close contact with the first heating substrate 10a. As a result, heat of the first heating substrate 10a is given further efficiently to the recording medium 41, which contributes to the heating of the recording medium 41, and in its turn, the heating of the transferred toner 42.

A size (diameter) of the through-hole 19a is about 0.3 to 0.5 mm, a width of the groove 19b is about 0.3 to 0.5 mm, and a depth of the groove 19b is about 0.2 to 0.3 mm. A small size blower or a small size vacuum pump (a vacuum chuck for semiconductor wafer) can be used as a suction tool. Reclamation of heat from the sucked heated air can be considered at a preheating section (preheating of the recording medium before and after the transferring). Further, as shown in FIG. 1A, it is preferable to form cover case 7 at the front surface side of the heating section 1 with the space of about 1 to 3 mm from the viewpoint of heat interception (effective use of heat) and prevention of scattering of the toner 42 powder. In FIG. 2D, the numeral 20 represents an abrasion resistance layer made of hard glass having a smooth surface. The recording medium 41 is pressed with the pressure roller 21 and the support portion opposing to the pressure roller 21, which is the extended portion of the first heating substrate 10a. The recording medium 41 slides on the abrasion resistance layer 20 of the first heating substrate 10a. Therefore, the abrasion resistance layer 20 which is smooth and is hardly abraded is formed so that the recording medium 41 moves smooth and the surface of the first heating substrate 10a should not be worn out. Since the heating element 12 is not formed in the vicinity of the abrasion resistance layer 20, the temperature there is not so high, however, there is a temperature rise to a certain extent due to heat conduction of the insulating substrate of first heating substrate 10a.

On the surfaces of the heating element 12 and the resistive element 13 for temperature measurement, the above-mentioned protection layer 17 is provided, and comes into direct contact with the back surface of the recording medium 41, which allows the temperature of the recording medium 41 to rise fast and is advantageous from the viewpoint of power saving. Further, the number of heating elements 12 is increased or decreased properly depending on a temperature of generated heat and a conveying speed of the recording medium 41 (in the case of a 70 μm thick paper of A4 size, by heating with an amount of heat of about 6 J during conveying of a sheet of paper, the toner 42 can be molten). In addition, in the example shown in FIG. 2D, the through-holes 19a and the grooves 19b are formed between the heating element 12 and the resistive element 13 for temperature measurement, and it is preferable to carry out the suction near the heating element 12 since the suction of the recording medium to the heating element 12 is easy. However, there is a problem such that it is difficult to measure the temperature of the heating element 12 accurately. Therefore, as shown in FIG. 2E, through-hokes and grooves for suction may be formed opposite to the heating element 12 with the resistive element 13 for temperature measurement being disposed therebetween.

FIG. 2E shows an example of a suction apparatus in which only the grooves are formed on the surface of the first heating substrate 10a. The suction apparatus is configured such that the groove 19b is formed so as to reach at least one edge of the surface of the first heating substrate 10a and a suction tool is connected to an end wall of the one edge of the first heating substrate 10a to make the pressure inside the groove 19b negative. In the case where the groove 19b reaches the both edges, the suction tool is connected to the both edges. Even in this structure, the recording medium 41 can be brought into contact with the first heating substrate 10a in the same manner as in the example shown in FIG. 2D. Other structure is the same as in FIG. 2D, and the same symbols are provided for the same portions, and explanations thereof are omitted. This structure can be applied to the structure shown in FIG. 2D. Namely, while the suction is performed at the through-holes 19a, the groove 19b can be extended to the end portion and a suction tool can be connected to the edge.

FIG. 2F shows another example of a suction apparatus, wherein first heating substrates 10a1 and 10a2 having one each of a heating element 12 and a resistive element 13 for temperature measurement as shown in FIG. 2C, etc., and a substrate 10a3 are arranged with spaces of 19c of, for example, about 0.1 to 0.5 mm, and a suction tool is connected to the spaces 19c. Instead of such spaces, it is possible to insert a porous material of metal or ceramic having suction holes having a diameter of about 0.1 to 0.3 mm or grooves having a width of about 0.1 to 0.3 mm between the substrates. In the case of the spaces 19c, the heating substrate can be configured in the same manner as in the structure shown in FIG. 2D by connecting peripheral parts or other suitable parts of the substrates to obtain good heat conduction or by forming, on the first heating substrate 10a3, the abrasion resistance layer 20 but not the heating element 12. As mentioned above, by arranging the individual heating substrates via the spaces or the porous materials, a suction apparatus can be formed using the spaces 19c or the holes. In FIG. 2F, a heating element is not formed on the leftmost substrate 10a3, and the two right-hand substrates 10a1 and 10a2 are provided with a heating element and a resistive element for temperature measurement which are not described in the drawing. In the leftmost substrate 10a3, an abrasion resistance layer is formed on its surface, but is omitted in the drawing. In addition, the individual first heating substrates 10a 1, 10a2 and 10a3 may be connected beforehand on the peripheries of the back surfaces thereof, or the substrate may not be separated into the three substrates completely and may remain connected at the peripheral parts thereof. Namely, the substrate may be one having the same structure as a substrate having slits thereon. Such a structure assures that the positions of the substrates do not deviate from each other and makes assembly easy.

FIG. 2G is a plan view showing the surface of the insulating substrate 5 of the fixing device shown in FIG. 1C. In this embodiment, the heating elements 12a, 12b and 12c for the heating section 1 are provided on the insulating substrate 5. The number of these heating elements 12 is not limited thereto, and more heating elements or less heating elements may be used. Further, the heating elements 12 may not have the same heat value so that the temperatures of the respective heating elements differ from each other, or a voltage to be applied to the respective heating elements 12 may be adjusted separately. As mentioned above, it is preferable that immediately after the transferring, the toner is heated to be changed into a softened state or a fluidized state. From that point of view, it is preferable that the temperature of the first heating element 12a located near the transfer section 3 is elevated easily and the temperature of the third heating element 12c at the side of the pressing and conveying section 2 is low. However, the temperature setting is not limited to that of this example.

FIG. 2H and FIG. 2I show other example of the surface of the insulating substrate 5 and an example of a dome-shaped surface (convex shape on the center portion) of the insulating substrate 5. The width and the number of heating elements 12 and the number of through-holes 19a and the number of grooves 19b of a suction apparatus can be set freely. Further, in this example, two electrodes for the transferring are formed, and the downstream side electrode 39b is formed as an electrode for separate charger to enable winding of the recording medium 41 on the photoreceptor 31 to be prevented. Furthermore, in this example, as mentioned above, a convex portion having a height of about 0.2 to 0.3 mm per a length of about 50 mm is formed around the center portion of the substrate, and the substrate is in a domed shape. Formation of such a shape enhances adhesion between the recording medium 41 and the heating element. There is a case where the insulating substrate 5 is not one piece, and a plurality of substrates are connected to form the insulating substrate 5, or each of the plurality of substrates may be in a domed-shape to have repeated convex and concave portions. When the through-holes 19a for the suction by the suction apparatus are formed on the concaved portions, adhesion to the recording medium 41 is further improved. However, even without the suction apparatus, adhesion is improved by the formation of the convex and concave portions. This domed-shape is not limited to the insulating substrate 5, and the heating substrates 10 such as the first heating substrates 10a may be formed in a domed-shape and a plurality of heating substrates may be disposed. In FIG. 2H and FIG. 2I, the same portions as in FIG. 2G are provided with the same reference numbers, and explanation thereof are omitted.

In the examples shown in FIG. 1C and FIG. 2G, the through-holes 19a and the thin grooves 19b are formed on the insulating substrate 5 in the same manner as shown in FIGS. 2D and 2E. These through-holes 19a are connected with a suction tool not shown in the drawing for the suction from the back surface of the insulating substrate 5 (opposite side of the recording medium 41). Further, the both ends of the groove 19b may be extended up to the both end portions of the insulating substrate 5 and connected with a suction tool without providing the through-holes. The through-holes 19a and/or the thin grooves 19b and the suction tool constitute a suction apparatus, thereby allowing the recording medium 41 disposed on the insulating substrate to be sucked, providing good contact between the surface of the insulating substrate and the recording medium 41, and easily efficiently transmitting, to the recording medium 41, heat generated by the heating element 12 formed on the surface of the insulating substrate 5. In this case, as compared with the case where the surface of the insulating substrate 5 is plane, when there is a convex (a curved portion) of not less than 0.2 mm in a somewhat domed-shape along the travelling direction, a contact pressure between the convex portion and the recording medium 41 becomes higher, and therefore, heat transmission is further increased. In such a case, when a portion of the insulating substrate where the heating element 12 is formed is in a convex form, heat transmission is further increased. A suction power of the suction apparatus may be as small as enabling a state of reduced pressure to be obtained, and strong suction obstructing the conveying of the recording medium 41 is not performed.

In the embodiment shown in FIG. 1B, the second heating substrate 10b is not provided in the heating section 1, and the first heating substrate 10a is extended to be a support for the pressure roller 21, and the abrasion resistance layer 20 is formed on the extended part of the first heating substrate 10a. Namely, the heating substrate having the structure as shown in FIG. 2D and FIG. 2E is used. The third heating substrate 10c is provided for exclusive use for heating of the pressure roller 21 and for temperature measurement. In FIG. 1B, the cover case 7 is omitted, and tilting of the fixing device is also omitted. However, the same configuration as in FIG. 1A is preferred. In this embodiment, the third heating substrate 10c for heating the pressure roller 21 is not used in common with the second heating substrate 10b, and therefore, it is preferable to bring the protection layer (cover substrate) 17 side of the side of the heating element 12 side into contact with the pressure roller 21, from the viewpoint of effective use of heat and accurate measurement of the temperature of the pressure roller 21. Other structure is the same as the structure shown in FIG. 1A. The same symbols are provided for the same portions as in FIG. 1A, and explanations thereof are omitted.

The embodiment shown in FIG. 1C is, as mentioned above, characterized in that the insulating substrate 5 is formed in series from the transfer section 3 to the pressing and conveying section 2, and the electrode 39 for transferring is also provided on the insulating substrate 5 at the transfer section 3. In the pressing and conveying section 2, the insulating substrate 5 is extended to form a support 22 at a portion opposing to the pressure roller 21. Namely the recording medium 41 is carried while being pressed with the support 22 of the insulating substrate 5 and the pressure roller 21. From this point of view, it is preferable that the outer surface of the pressure roller 21 has some elasticity. In the pressing and conveying section 2, the toner is heated with heat transmitted through the insulating substrate 5. In this pressing and conveying section 2, the toner 42 is heated not to be changed into a fluidized state (a molten state). However, if the toner 42 changed into a fluidized state in the heating section 1 is cooled rapidly, there is a case where the toner cannot be adhered to the recording medium sufficiently even by pressing. Therefore, since a softened state of the toner need to be kept to a certain extent, it is preferable to heat the toner to some extent. A fourth heating element 12d may be formed on the support 22 if it is necessary. Even in that case, too, it is not necessary to increase the temperature of the fourth heating element 12d to be as high as the temperatures of the heating elements 12a-12c in the heating section 1, and therefore, a shape of the fourth heating element 12d or a voltage to be applied to the fourth heating element 12d is adjusted so that the temperature of the fourth heating element 12 becomes lower than the temperatures of the heating elements 12a to 12c. With such a configuration mentioned above, not only an amount of heat generated in the heating section 1 can be used effectively from the transfer section 3 to the pressing and conveying section 2, but also scattering of fine powders of the toner 42 can be prevented since the toner 42 is heated at the same time as the transferring.

In the example shown in FIG. 1C and FIG. 2G, a fifth heating element 12e is provided upstream of the transfer section 3. This fifth heating element 12e is formed to the above-mentioned fifth heating substrate and heats the thin recording medium 41 from its back surface side. Therefore, when the recording medium 41 is paper or the like, it is apt to absorb moisture, and moisture is contained in it, it is easily dried before the transferring of the toner 42. In addition, a problem such that after the fixing, moisture is evaporated and irregularity is formed on the surface of the toner 43 can be prevented easily. In FIG. 1C, numeral 55 represents a feed roller for the recording medium 41. Further, even in the case of providing the fifth heating element 12e, as mentioned above, the temperature of the fifth heating element 12e is set to be low lest the temperature of the photoconductor 31 is elevated to be too high.

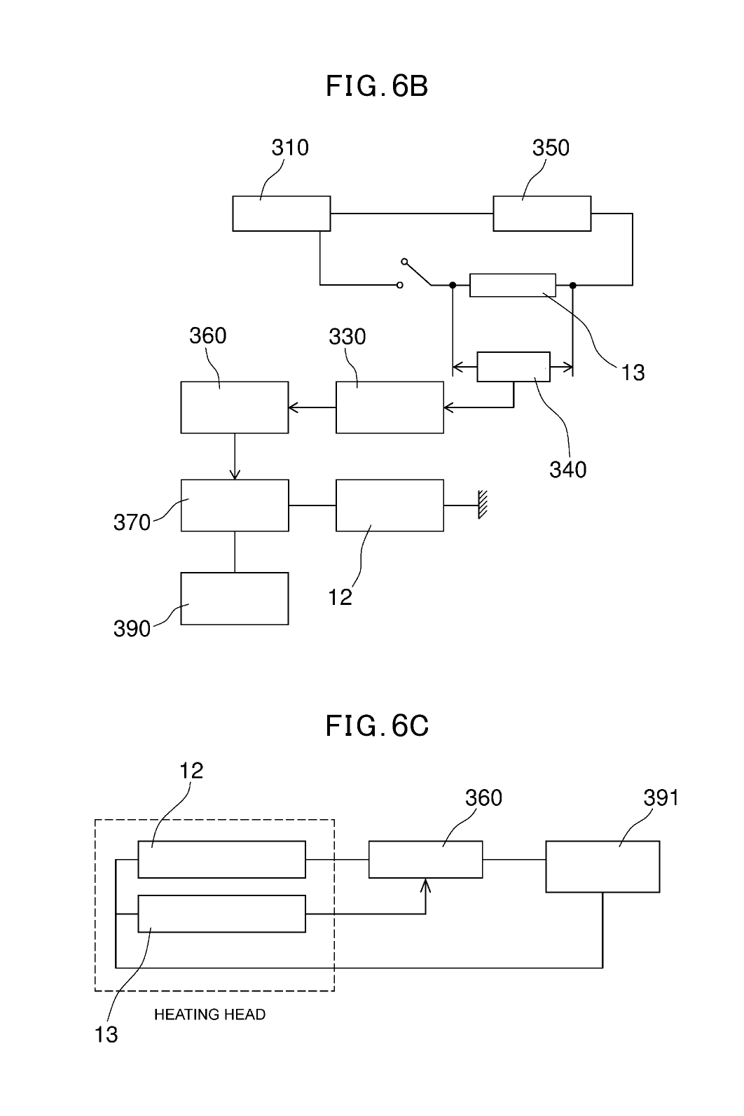

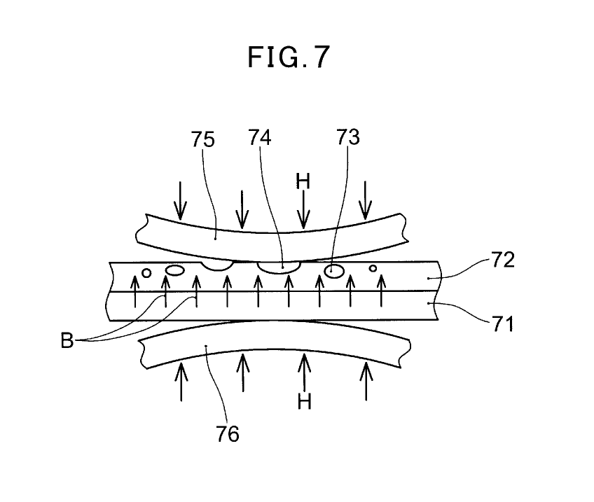

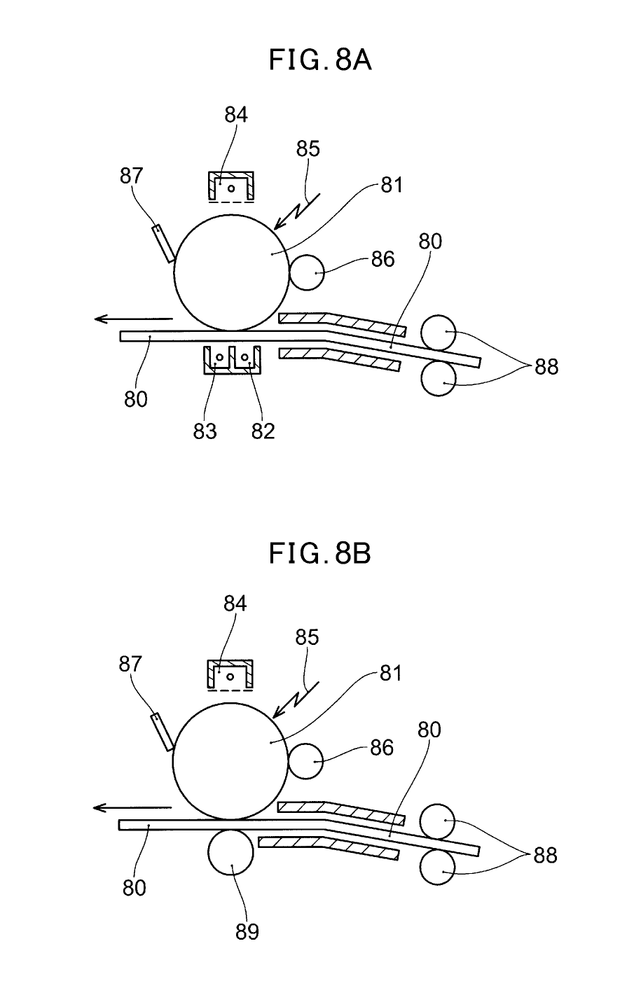

As mentioned above, if the temperature for heating the toner 42 is too low, the toner cannot be changed into a softened state or a fluidized state and cannot be fixed sufficiently. Further, if it is too high, a part of the toner 42 adheres to the pressure roller 21 in the pressing and conveying section 2, which is not preferable. Therefore, the temperatures of the heating substrates 10 need to be controlled accurately. Temperature control means (drive circuit) of the fixing device shown in FIG. 1A, etc. is shown in FIG. 6A. This is an example of driving the drive circuit with an AC or DC power source 390, wherein a voltage and an applied time of a battery or a commercial power source 390 are adjusted by pulse drive, a transformer or the like, and a drive power is supplied to the electrode 14 (see FIG. 2A) to be connected to the heating element 12 via an adjusting section 370 for adjusting an applied power. As a result, an AC power source can be used as it is, and a voltage of commercial AC power source 390 is adjusted with the power adjusting section 370 to give a desired temperature of the heating element. In the case of, for example, an AC power source 390, an AC power control means such as a triac or a thyristor can be used for the adjusting section 370. As a result, a DC power source is not necessary, and a power source cooling fan is also not required. Meanwhile, a battery of a DC power source can be used. Further though not described in the drawing, heating can be performed by pulse drive for pulse application. In that case, an applied power can also be adjusted by changing a duty cycle instead of changing a voltage. Furthermore, in the case of the pulse application, an output can also be changed by phase control (PDM).

The temperature of the insulating substrate 11 can be detected by measuring a voltage V between both ends of the resistive element 13 using a constant electric current supplied from a constant current circuit 350 with an electric current of a power source 310, and by obtaining a resistance value of the resistive element 13 for temperature measurement at that time. Namely a temperature of the insulating substrate 11 (see FIG. 2A) can be obtained from variation of the resistance value of the resistive element 13; and then adjusting an applied voltage using so as to obtain the determined temperature in the power adjusting section 370. The power adjusting section 370 is effective for making the temperatures of the respective heating elements 12 uniform or different particularly in the case of heating with a plurality of heating elements 12. Therefore, in the case of providing a plurality of resistive elements 13 for temperature measurement, it is preferable to measure the respective temperatures in the vicinity thereof and adjust an applied voltage for each of the heating elements 12. This embodiment shows the case of using a DC power source, and even in the case of an AC power source, temperature detection can be made by the control of an effective value.

This theory of temperature measurement will be explained below in more detail by referring to FIG. 6B. The temperature can be obtained by, for example, connecting a constant current circuit 350 and the resistive element 13 for temperature measurement in series at both ends of the DC power source 310, for example, for measurement; measuring voltages V at both ends of the resistive element 13 for temperature measurement and obtaining a resistance valve of the resistive element 13 at that time by dividing the voltages by a constant current in the temperature detecting means 330; and calculating the temperature from the obtained resistance value and the previously known temperature coefficient (varies depending on a material) of the resistive element 13 for temperature measurement. In the case of AC, an alternating current is subjected to half-wave rectification, and the temperature is measured by a trigger action. By controlling an electric power to be applied at both ends of the heating element 12 with a control means 360 via the power adjusting section 370 according to the detected temperature, the temperature of the insulating substrate 11 can be kept at a desired temperature. In the temperature control of the heating element 12 by the control means 360, as mentioned above, an applied voltage may be pulse voltage and a duty cycle of the pulse may be changed, or the voltage itself may be changed. In the example shown in FIG. 6B, the constant current circuit 350 is provided, however, instead of it, there may be employed a method such that a reference resistance is provided at a place where a temperature does not change, a voltage of the reference resistance is measured to obtain its current, and a voltage at both ends of the resistive element 13 for temperature measurement may be measured with a V detector 340. The power source 310 for measurement is not limited to a DC power source. Even in the case of AC, a pulse-like constant current can be obtained.

In the above-mentioned example, the power source for the heating element 12 is separated from the power source for the resistive element 13 for temperature measurement. However, by sharing the power source for the both, a commercial power source of, for example, AC 100 V to 240 V can be used. A circuit diagram of the example is shown in FIG. 6C. The heating element 12 and the resistive element 13 for temperature measurement are connected to a commercial power source 391 in parallel, and a control means 360 is connected between the heating element 12 and the commercial power source 391. A voltage to be applied to the heating element 12 is controlled by controlling the control means 360 according to the temperature detected from the resistive element 13 for temperature measurement. In addition, the heating element 12 and the resistive element 13 for temperature measurement are formed on the insulating substrate.

What is claimed is:

1. A fixing device comprising:
a transfer section for transferring a toner formed on a photoreceptor to a recording medium, the toner being attached by developing an electrostatic latent image,
a heating section provided at a downstream side of the recording medium from the transfer section, for heating the toner transferred in the transfer section, and
a pressing and conveying section provided at a downstream side of the recording medium from the heating section for conveying the recording medium while pressing, with a pressure roller, a surface of the recording medium on which the toner is attached,
wherein in the heating section, heating is performed by a first heating substrate from an opposite side to the surface of the recording medium on which the toner is transferred and/or a second heating substrate from the side of the surface of the recording medium on which the toner is transferred, the second heating substrate being provided apart from the recording medium, and the heating is continued until the toner transferred on the recording medium becomes a softened state or a fluidized state, and in the pressing and conveying section, the toner is pressed at a temperature equal to or below a temperature of the toner at which the toner is in a softened state or in a fluidized state, and
wherein in the pressing and conveying section, an extension part of the first heating substrate or a fourth heating substrate which is different from the first heating substrate is provided opposite to the pressure roller with the recording medium being disposed therebetween, and the recording medium is subjected to pressing with the pressure roller and the first heating substrate or the fourth heating substrate.

2. The fixing device of claim 1, wherein the structure of the first heating substrate is such that the first heating substrate is extended up to a position where an extended portion of the first heating substrate is located opposite to the pressure roller with the recording medium being disposed therebetween and a heating element is not formed on the extended portion opposed to the pressure roller.

3. The fixing device of claim 1, further comprising an insulating substrate that is continuously provided throughout the transfer section, the heating section and the pressing and conveying section and comes into contact with a back surface of the recording medium opposed to the surface on which the toner is attached, wherein an electrode for transferring is provided on the insulating substrate for the transfer section, a heating element is provided on the insulating substrate for the heating section, wherein the heating element and the insulating substrate constitute the first heating substrate, and in the pressing and conveying section, the insulating substrate is formed as a support for receiving a pressure of the pressure roller.

4. The fixing device of claim 3, wherein two electrodes are formed as the electrode for transferring and one of the electrodes of downstream side is used as a separate charger.

5. The fixing device of claim 3, wherein a portion of the insulating substrate on which the heating element is disposed is formed into a convex shape.

6. The fixing device of claim 1, wherein a fifth heating substrate for heating the recording medium is provided at an upstream side of the transfer section on the recording medium.

7. The fixing device of claim 3, wherein a fifth heating element for heating the recording medium is formed on a surface of the insulating substrate at an upstream side of the transfer section.

8. The fixing device of claim 2, wherein an abrasion resistance layer is formed on the first heating substrate at a position opposing to the pressure roller with the recording medium being disposed between the first heating substrate and the pressure roller.

9. The fixing device of claim 3, wherein an abrasion resistance layer is formed on the insulating substrate at a position opposing to the pressure roller with the recording medium being disposed between the insulating substrate and the pressure roller.

10. The fixing device of claim 1, wherein a suction apparatus for suction of the recording medium is formed on the first heating substrate.

11. The fixing device of claim 3, wherein a suction apparatus for suction of the recording medium is formed on the insulating substrate.

12. The fixing device of claim 2, wherein the first heating substrate is disposed in a vicinity of a transfer device of the transfer section so as to enable the recording medium transferred at the transfer section to be heated immediately.

13. The fixing device of claim 1, wherein a third heating substrate is disposed in contact with the pressure roller at an upstream side of a contact portion of the pressure roller with the recording medium in the pressing and conveying section.

14. The fixing device of claim 1, wherein at least one of the heating substrates comprises:
an insulating substrate,
a band-like heating element formed on one surface of the insulating substrate for heating the insulating substrate,
at least a pair of electrodes being capable of flowing electric current in a lengthwise direction of the heating element,
a resistive element for temperature measurement of the insulating substrate formed on the insulating substrate along the heating element in a vicinity of the heating element, and
at least a pair of measurement terminal for measuring an electric resistance within a given length of the resistive element.

15. The fixing device of claim 1, wherein in the cross-section of the heating substrate along the travelling direction of the recording medium, a center portion of the heating substrate is formed in a convex shape.

16. The fixing device of claim 13, wherein the third heating substrate comprises: an insulating substrate, a band-like heating element formed on one surface of the insulating substrate for heating the insulating substrate, at least a pair of electrodes being capable of flowing electric current in a lengthwise direction of the heating element, a resistive element for temperature measurement of the insulating substrate formed on the insulating substrate along the heating element in a vicinity of the heating element, and at least a pair of measurement terminal for measuring an electric resistance within a given length of the resistive element, and is used in common with the second heating substrate by providing the third heating substrate such that the surface of the third heating substrate where the heating element is provided is in parallel with the recording medium and the side face of the insulating substrate of the third heating substrate comes into contact with the pressure roller.

17. The fixing device of claim 1, wherein a heat radiation layer is formed on a surface side of the heating element of the second heating substrate.

18. The fixing device of claim 1, wherein a discharged paper accumulating section for accumulating paper is provided at a downstream side of the pressing and conveying section, and a cover case for integrally enclosing the discharged paper accumulating section, the pressing and conveying section, the heating section and at least a part of a back surface of the recording medium at the transfer section.

19. The fixing device of claim 3, wherein a feed roller for conveying the recording medium is provided at an upstream side of the transfer section on the surface of the recording medium where the toner is transferred.

20. The fixing device of claim 3, wherein a plurality of heating elements provided on the heating section are disposed in parallel with each other along the travelling direction of the recording medium, and resistive elements for temperature measurement of the insulating substrate are formed beside the respective heating elements.

21. The fixing device of claim 20, wherein widths or applied voltages of the plurality of the heating elements differ from each other so that a temperature of a heating element at the transfer section side is higher than a temperature of a heating element at the pressing and conveying section side.

22. The fixing device of claim 1, wherein in the heating section, convex and concave portions are formed on a surface of the first heating substrate and a heating element is formed on the convex portion such that the recording medium is sucked on a heating element of the first heating substrate side.

23. A fixing method for fixing a toner to a recording medium by:
providing a transfer section for transferring the toner showing an image on one surface of the recording medium, by an electrophotographic process,
providing a heating section for changing the toner from a solid state to a softened state or a fluidized state by heating the toner from a side of the toner-transferred surface of the recording medium apart from the surface, and/or from an opposite side of the recording medium while carrying the recording medium, and
providing a pressing and conveying section for carrying the recording medium while pressing it,
wherein the recording medium having the toner turned into a softened state or a fluidized state is conveyed between a pressure roller provided at the toner side of the recording medium and a first heating substrate disposed at an opposite side of the recording medium or a fourth heating substrate different from the first heating substrate, to be pressed at a temperature of the toner which is not higher than a temperature of the toner at the heating section.

24. The fixing method of claim 23, wherein when pressing with the pressure roller, the pressing is carried out while heating the recording medium at a temperature equal to or lower than a temperature of the toner in the softened state with interposing the recording medium between the pressure roller and an extending portion, in which a heating element is not provided, of an insulation substrate of the heating substrate of the heating section by using heat conducting through the insulating substrate.

25. The fixing method of claim 23, wherein an insulating substrate is continuously provided throughout the transfer section, the heating section and the pressing and conveying section, and an electrode for transferring at the transfer section and a heating element for heating at the heating section are provided respectively on a surface of the insulating substrate, and an extended part of the insulating substrate is formed as a support of the pressing and conveying section.

26. The fixing method of claim 23, wherein before transferring the image to the recording medium, moisture inside the recording medium is evaporated by heating the recording medium.

27. The fixing method of claim 23, wherein the heating in the heating section is carried out by providing a heating substrate on a back surface of the recording medium opposite to the surface having the transferred toner and by bringing the recording medium into close contact with the heating substrate by means of vacuum evacuation with a suction apparatus provided through the heating substrate, or at an upstream side or downstream side of the heating substrate.

28. The fixing method of claim 23, wherein the heating in the heating section is carried out by providing a plurality of heating elements along a travelling direction of the recording medium in the heating section and having a temperature gradient so that a temperature at the transfer section side is high and a temperature at the pressing and conveying section side is low.

29. The fixing method of claim 23, wherein a discharged paper accumulating section for accumulating discharged paper is provided at a downstream side of the pressure roller; and the discharged paper accumulating section, the pressing and conveying section for conveying the recording medium while pressing it, the heating section and at least a surface side of the recording medium opposite to the toner-transferred surface at the transfer section are integrally enclosed with a cover case, and the conveying of the recording medium is carried out by inclining a conveying line level so that the transfer section side is higher than the discharged paper accumulating section.

30. A fixing method for fixing a toner transferred at a transfer section on a recording medium, while conveying the recording medium through the transfer section, a heating section and a pressing and conveying section, the method being characterized in that a fine powder of the toner is prevented from scattering by heating the transferred toner immediately after the transferring at the transfer section.
